(19) United States
(12) Patent Application Publication
(10) Pub. No.: US 2009/0185700 A1
(43) Pub. Date: Jul. 23, 2009

(54) Vibration transducer and manufacturing method therefor

(75) Inventor: Toshihisa Suzuki, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/290,193

(22) Filed: Oct. 28, 2008

(30) Foreign Application Priority Data
Oct. 29, 2007 (JP) P2007-280597

(51) Int. Cl. H04R 11/04

(52) U.S. Cl. 381/174

(57) ABSTRACT

A vibration transducer (or a pressure transducer) is constituted of a cover, a plate, a diaphragm, and a substrate having a back cavity. The diaphragm is positioned above the substrate so as to cover the opening of the back cavity. The plate has a radial gear-like shape constituted of a center portion positioned just above the diaphragm and a plurality of joints. The cover horizontally surrounds the plate with slits therebetween so that the cover is electrically separated from the plate and is positioned above the periphery of the diaphragm. A plurality of pillar structures joins the plurality of joints of the plate so as to support the plate above the diaphragm with a gap layer therebetween. By reducing the widths of slits, it is possible to prevent foreign matter from entering into the air layer between the plate and the diaphragm.

### BACKGROUND OF THE INVENTION

1. Field of the Invention

The present invention relates to vibration transducers and vibration transducers such as miniature condenser microphones serving as MEMS (Micro Electro Mechanical System) sensors.

The present invention also relates to manufacturing methods adapted to vibration transducers and pressure transducers.

The present application claims priority on Japanese Patent Application No. 2007-280597, the content of which is incorporated herein by reference.

2. Description of the Related Art

Conventionally, miniature condenser microphones have been developed and manufactured by way of semiconductor device manufacturing methods. Related technologies are disclosed in various documents such as Patent Documents 1-3 and Non-Patent Document 1.
Patent Document 1: Japanese Unexamined Patent Application Publication No. H09-508777
Patent Document 2: Japanese Patent Application Publication No. 2004-506394
Patent Document 3: U.S. Pat. No. 4,776,019
Non-Patent Document 1: MSS-01-34 published by Japanese Institute of Electrical Engineers

Condenser microphones are referred to as MEMS microphones, a typical example of which includes a pair of opposite electrodes, i.e. a diaphragm and a plate each formed using thin films, which are mutually distanced from each other and are supported above a substrate. When the diaphragm vibrates relative to the plate due to sound waves, the electrostatic capacitance (of a condenser constituted of the diaphragm and plate) therebetween is varied due to the displacement thereof, wherein variations of electrostatic capacitance are converted into electric signals.

In order to detect small pressure variations in a miniature condenser microphone serving as an MEMS sensor, a plurality of cutouts is formed in a diaphragm whose circumferential periphery is not entirely fixed in position in parallel with a plate. In this type of the condenser microphone in which a plurality of cutouts is formed in the diaphragm, the diaphragm is exposed on the surface of a sensor die incorporated in a package having a through-hole, by which a foreign matter may likely enter into a gap between the diaphragm and the plate.

### SUMMARY OF THE INVENTION

It is an object of the present invention to provide a vibration transducer and a pressure transducer, each of which is constituted of a substrate, a diaphragm, and a plate having a radial shape and which prevents a foreign matter from entering into a gap between the diaphragm and the plate.

It is another object of the present invention to provide a manufacturing method adapted to the vibration transducer and the pressure transducer.

In a first embodiment of the present invention, a vibration transducer includes a substrate having a back cavity having an opening; a diaphragm having a conductive property, which is formed above the substrate so as to cover the opening of the back cavity in plan view; a plate having a conductive property, which is formed above the diaphragm and which is constituted of a center portion positioned opposite to the diaphragm and a plurality of joints extended from the center portion in a radial manner; an insulating support layer, which joins the joints of the plate so as to support the plate above the diaphragm with a gap layer therebetween while insulating the plate from the diaphragm and which has a ring-shaped interior surface for surrounding the air layer therein; and a cover, which is formed using at least a part of a film material used for forming the plate, which joins the insulating support layer while projecting inwardly from the ring-shaped interior surface so as to surround the plate therein, and which is positioned opposite to the diaphragm with the gap layer therebetween, wherein the cover is electrically separated from the plate via a slit, and wherein the diaphragm vibrates relative to the plate so as to vary electrostatic capacitance formed between the diaphragm and the plate.

In the above, the cover is formed using at least a part of the film material used for forming the plate and is positioned opposite to the periphery of the diaphragm which is not positioned opposite to the plate. That is, the periphery of the diaphragm which is not covered with the plate is covered with the cover which is formed using the film material formed above the diaphragm. Since the air layer formed between the diaphragm and the plate is extended into the gap between the diaphragm and the cover, it is possible for the cover to cover the periphery of the diaphragm without disturbing vibration of the diaphragm. Since the cover is electrically separated from the diaphragm via a slit, it is possible to form wiring without forming parasitic capacitance between the cover and the diaphragm. By reducing the width of the slit used for separating the cover from the plate, it is possible to prevent foreign matter from entering into the air layer between the diaphragm and the plate.

In manufacturing, a plurality of plate holes is formed in the plate; a plurality of cover holes is formed in the cover; then, isotropic etching is performed using a mask corresponding to the plate and the cover so as to remove a part of the insulating support layer, thus forming the air layer between the plate and the diaphragm. Since the cover and the plate are used as an etching mask so as to form the insulating support layer, it is possible to reduce the number of masks (required in manufacturing), thus reducing the manufacturing cost.

In other words, it is preferable that a plurality of holes be formed in the plate and the cover so as to transmit an etchant therethrough, thus simultaneously forming the gap layer and the insulating support layer by way of isotropic etching. It is preferable that the holes be formed with prescribed dimensions and sizes for transmitting the etchant therethrough; hence, it is possible to reduce the sizes of holes not transmitting “solid” foreign matter therethrough.

It is preferable that the diaphragm be constituted of a center portion positioned opposite to the center portion of the plate and a plurality of arms extended from the center portion in a radial manner. It is preferable that the joints of the plate be positioned between the arms of the diaphragm in plan view and be supported by the insulating support layer. By forming the diaphragm having a radial-gear-like shape constituted of the center portion and the arms, it is possible to reduce the rigidity of the diaphragm, thus improving the sensitivity of the vibration transducer. Since the joints of the plate are supported by the insulating support layer at the prescribed positions vertically matching the cutouts formed between the arms of the diaphragm in plan view, it is possible to reduce the substantial length of the plate bridged across the insulating support layer, thus increasing the rigidity of the plate. Increasing the rigidity of the plate increases the bias voltage applied to the diaphragm and the plate, thus improving the sensitivity of the vibration transducer.

In a second embodiment of the present invention, a pressure transducer is constituted of a substrate having an opening on the surface thereof; a plate formed above the substrate and constituted of a center portion, which overlaps with the opening of the substrate in plan view, and a plurality of joints (or arms) which are extended in a radial direction from the center portion and whose distal ends are fixed to the surface of the substrate via an insulating layer; a diaphragm formed between the substrate and the plate and constituted of a center portion, which is positioned opposite to the center portion of the plate, and a plurality of arms (or bands) which are extended in a radial direction from the center portion so as not to overlap with the joints of the plate in plan view and whose distal ends having flexibility are fixed to the surface of the substrate via an insulating layer, wherein the diaphragm is deformed due to pressure applied to the center portion in a range between the substrate and the plate; a cover having a plurality of projections projecting inwardly in a circumferential direction, wherein the cover is shaped to engage with but is physically separated from the plate with a slit therebetween in such a way that the projections thereof are positioned in the cutouts formed between the joints of the plate adjoining together; and a cover support which is inserted between the cover and the diaphragm so as to support the cover in parallel with the surface of the substrate in a prescribed region close to the center portion rather than the distal ends of the arms of the diaphragm, thus physically separating the cover from the diaphragm.

Since the cover is insulated from the plate with the slit therebetween, no parasitic capacitance occurs between the cover and the diaphragm. The arms of the diaphragm are covered with the cover which is physically separated from the plate with the slit therebetween, whereby the peripheral region of the diaphragm which is not covered with the plate is covered with the cover. It is possible to prevent foreign matter from entering into the gap between the diaphragm and the plate. Due to the insertion of the cover support, it is possible to prevent the prescribed region of the cover, which is positioned close to the center portion of the plate, from being deformed and brought into contact with the diaphragm.

In the above, it is preferable that the diaphragm be composed of a lower conductive film while both the cover and the plate be composed of an upper conductive film. This simplifies the layered structure of the pressure transducer, thus reducing the manufacturing cost. Since the arms of the diaphragm are not positioned opposite to the plate, it is possible to prevent parasitic capacitance from occurring in the low-amplitude regions of the arms of the diaphragm which vibrate with small amplitudes based on the distal ends fixed to the substrate even when each of the diaphragm and the cover is composed of a single-layered conductive film.

It is preferable that a plurality of holes be formed in both of the plate and the cover so as to transmit an etchant, which is used in etching for forming a gap between the plate and the diaphragm, a gap between the cover and the diaphragm, and the cover support in a self-alignment manner, therethrough. They can be formed in a self-alignment manner by way of isotropic etching using the plate and the cover as a mask. This further reduces the manufacturing cost of the pressure transducer. In this connection, the holes formed in the plate and the cover are formed in prescribed shapes and sizes for transmitting the etchant therethrough. In other words, the sizes of the holes can be easily reduced to prevent dust and foreign matter, which may damage the function of the pressure transducer, from transmitting therethrough.

In a manufacturing method of the above pressure transducer comprises the steps of: forming a lower insulating film on the substrate; forming a lower conductive film used for forming the diaphragm on the lower insulating film; forming an upper insulating film on the lower conductive film; forming an upper conductive film used for forming the plate and the cover on the upper insulating film; and performing isotropic etching using a mask corresponding to the substrate, the plate, and the cover so as to partially remove the lower insulating film and the upper insulating film, thus forming a gap between the substrate and the diaphragm and a gap between the diaphragm and the plate while forming the cover support by use of the remaining portions of the lower insulating film and the upper insulating film.

The above manufacturing method makes it possible to form the gap between the plate and the diaphragm, the gap between the cover and the diaphragm, and the cover support in a self-alignment manner; hence, it is possible to reduce the manufacturing cost of the pressure transducer.

### BRIEF DESCRIPTION OF THE DRAWINGS

These and other objects, aspects, and embodiments of the present invention will be described in more detail with reference to the following drawings.

FIG. 1 is a plan view showing a sensor chip corresponding to an MEMS structure of a condenser microphone in accordance with a first embodiment of the present invention.

FIG. 2 is a longitudinal sectional view of the sensor chip of the condenser microphone.

FIG. 3 is an exploded perspective view of the sensor chip of the condenser microphone.

FIG. 4A is a circuit diagram showing an equivalent circuit not including a guard.

FIG. 4B is a circuit diagram showing an equivalent circuit including the guard.

FIG. 5 is a sectional view used for explaining a first step of a manufacturing method of the condenser microphone.

FIG. 6 is a sectional view used for explaining a second step of the manufacturing method of the condenser microphone.

FIG. 7 is a sectional view used for explaining a third step of the manufacturing method of the condenser microphone.

FIG. 8 is a sectional view used for explaining a fourth step of the manufacturing method of the condenser microphone.

FIG. 9 is a sectional view used for explaining a fifth step of the manufacturing method of the condenser microphone.

FIG. 10 is a sectional view used for explaining a sixth step of the manufacturing method of the condenser microphone.

FIG. 11 is a sectional view used for explaining a seventh step of the manufacturing method of the condenser microphone.

FIG. 12 is a sectional view used for explaining an eighth step of the manufacturing method of the condenser microphone.

FIG. 13 is a sectional view used for explaining a ninth step of the manufacturing method of the condenser microphone.

FIG. 14 is a sectional view used for explaining a tenth step of the manufacturing method of the condenser microphone.

FIG. 15 is a sectional view used for explaining an eleventh step of the manufacturing method of the condenser microphone.

FIG. 16 is a sectional view used for explaining a twelfth step of the manufacturing method of the condenser microphone.

FIG. 17 is a sectional view used for explaining a thirteenth step of the manufacturing method of the condenser microphone.

FIG. 18 is a longitudinal sectional view showing a part of the detailed constitution of the sensor chip of the condenser microphone.

FIG. 19 is a longitudinal sectional view showing another part of the detailed constitution of the sensor chip of the condenser microphone.

FIG. 20 is a plan view showing a variation of a cover which has an interior space for installing a plate having a gear-like shape.

FIG. 21 is a plan view showing the constitution of a sensor die included in a condenser microphone, i.e. a pressure transducer, in accordance with a second embodiment of the present invention.

FIG. 22A is a sectional view taken along line A-A in FIG. 21.

FIG. 22B is a sectional view taken along line B-B in FIG. 21.

FIG. 22C is a sectional view taken along line C-C in FIG. 21.

FIG. 22D is a sectional view taken along line D-D in FIG. 21.

FIG. 23 is an exploded perspective view of the sensor die of the condenser microphone.

FIG. 24A is a circuit diagram showing an equivalent circuit not including a guard.

FIG. 24B is a circuit diagram showing an equivalent circuit including the guard.

FIG. 25 is a sectional view taken along line E-E in FIG. 21 used for explaining a first step of a manufacturing method of the condenser microphone.

FIG. 26 is a sectional view used for explaining a second step of the manufacturing method of the condenser microphone.

FIG. 27 is a sectional view used for explaining a third step of the manufacturing method of the condenser microphone.

FIG. 28 is a sectional view used for explaining a fourth step of the manufacturing method of the condenser microphone.

FIG. 29 is a sectional view used for explaining a fifth step of the manufacturing method of the condenser microphone.

FIG. 30 is a sectional view used for explaining a sixth step of the manufacturing method of the condenser microphone.

FIG. 31 is a sectional view used for explaining a seventh step of the manufacturing method of the condenser microphone.

FIG. 32 is a sectional view used for explaining an eighth step of the manufacturing method of the condenser microphone.

FIG. 33 is a sectional view used for explaining a ninth step of the manufacturing method of the condenser microphone.

FIG. 34 is a sectional view used for explaining a tenth step of the manufacturing method of the condenser microphone.

FIG. 35 is a sectional view used for explaining an eleventh step of the manufacturing method of the condenser microphone.

FIG. 36 is a sectional view used for explaining a twelfth step of the manufacturing method of the condenser microphone.

FIG. 37 is a sectional view used for explaining a thirteenth step of the manufacturing method of the condenser microphone.

FIG. 38 is a sectional view used for explaining a fourteenth step of the manufacturing method of the condenser microphone.

FIG. 39 is a sectional view used for explaining a fifteenth step of the manufacturing method of the condenser microphone.

FIG. 40 is a sectional view used for explaining a sixteenth step of the manufacturing method of the condenser microphone.

FIG. 41 is a sectional view used for explaining a seventeenth step of the manufacturing method of the condenser microphone.

FIG. 42 is a plan view showing the shape and alignment of cover holes formed in a cover in relation to a diaphragm in the sensor die.

FIG. 43 is a plan view showing the shape and alignment of diaphragm holes formed in an arm of the diaphragm in the sensor die.

FIG. 44 is a plan view showing the shape and alignment of cover holes formed in a cover in relation to a diaphragm in the sensor die in accordance with a first variation of the second embodiment.

FIG. 45 is a plan view showing the shape and alignment of diaphragm holes formed in an arm of the diaphragm in the sensor die in accordance with the first variation of the second embodiment.

FIG. 46 is a plan view showing the shape and alignment of cover holes formed in a cover in relation to a diaphragm in the sensor die in accordance with a second variation of the second embodiment.

FIG. 47 is a plan view showing the shape and alignment of diaphragm holes formed in an arm of the diaphragm in the sensor die in accordance with the second variation of the second embodiment.

FIG. 48A is a sectional view taken along line D-D in FIG. 1, which is used for explaining a first step of an etching process on upper and lower insulating films in proximity to arms of the diaphragm.

FIG. 48B is a sectional view used for explaining a second step of the etching process.

FIG. 48C is a sectional view used for explaining a third step of the etching process.

FIG. 48D is a sectional view used for explaining a fourth step of the etching process.

FIG. 48E is a sectional view used for explaining a fifth step of the etching process.

### DESCRIPTION OF THE PREFERRED EMBODIMENTS

The present invention will be described in further detail by way of examples with reference to the accompanying drawings.

### 1. First Embodiment

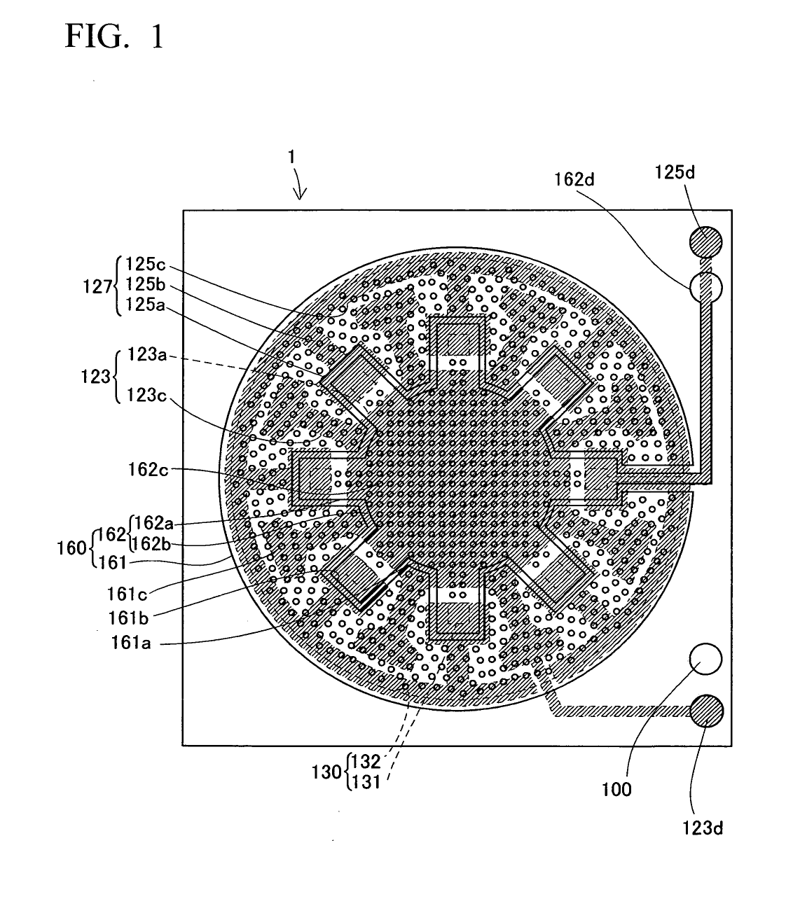

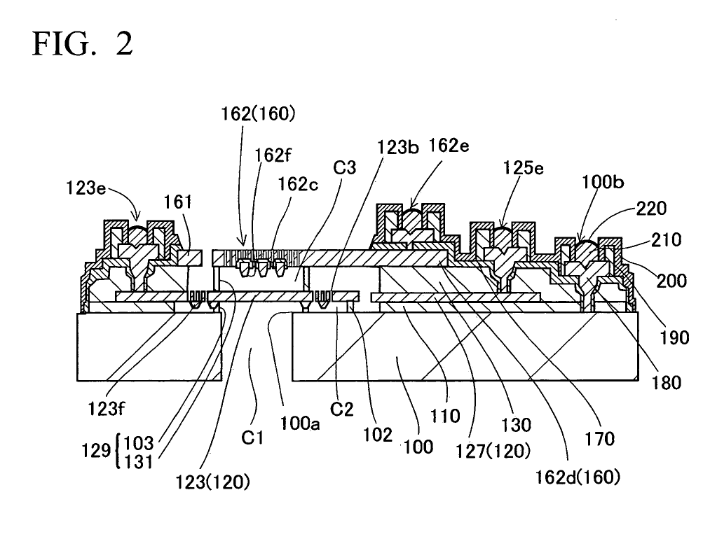

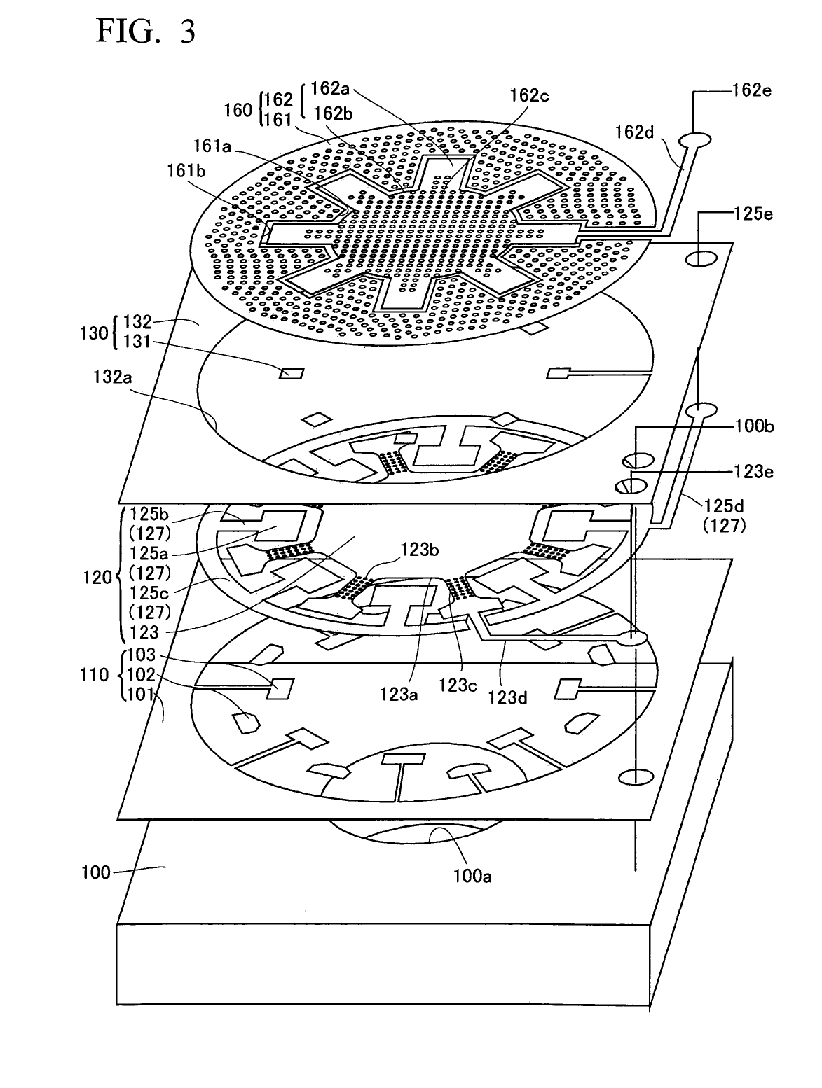

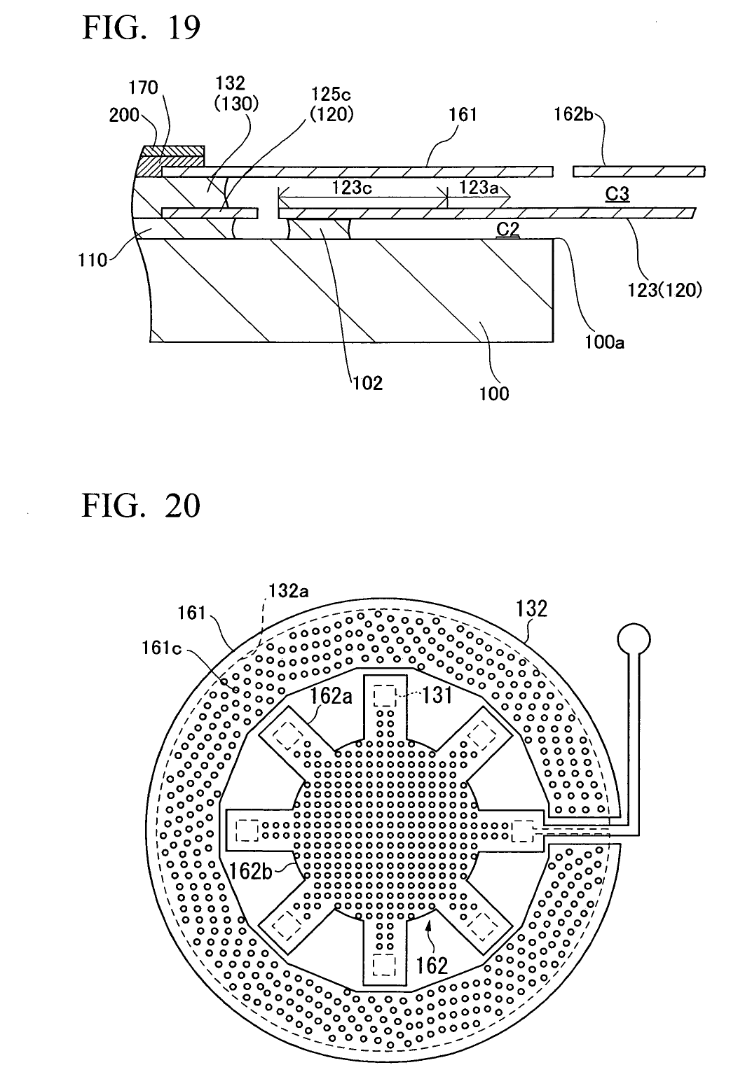

FIG. 1 shows a sensor chip corresponding to an MEMS structure of a condenser microphone 1 in accordance with a first embodiment of the present invention. FIG. 2 is a longitudinal sectional view of the sensor chip of the condenser microphone 1. FIG. 3 shows the lamination structure of the sensor chip of the condenser microphone 1. FIGS. 18 and 19 show the detailed constitution of the sensor chip of the condenser microphone 1. In FIG. 1, hatching areas indicate the formation area of a lower conductive layer 120. The condenser microphone 1 is constituted by the sensor chip, a circuit chip (including a power circuit and an amplifier, not shown), and a package (not shown) for storing the sensor chip and the circuit chip.

The sensor chip of the condenser microphone 1 is formed using deposited films, namely a lower insulating film 110, a lower conductive film 120, an upper insulating film 130, an upper conductive film 160, and a surface insulating film 170, which are laminated on a substrate 100. For the sake of convenience, upper layers formed above the upper conductive layer 160 are not shown in FIG. 1. The lamination structure of the above films included in the MEMS structure of the condenser microphone 1 will be described below.

The substrate 100 is composed of p-type monocrystal silicon; but this is not a restriction. It is required that the substrate 100 be composed of materials having adequate rigidity, thickness, and strength for depositing films and for supporting laminated films. A through-hole whose opening 100a forms a back cavity C1 is formed in the substrate 100.

The lower insulating film 110 joining the substrate 100, the lower conductive film 120, and the upper insulating film 130 is a deposited film composed of silicon oxide (SiOx).

The lower insulating film 110 joining the substrate 100, the lower conductive film 120, and the upper insulating film 130 is a deposited film composed of silicon oxide (SiOx). The lower insulating film 110 is used to form a plurality of diaphragm supports 102 which are aligned in a circumferential manner with equal spacing therebetween, a plurality of guard insulators 103 which are aligned in a circumferential manner with equal spacing therebetween and which are arranged inwardly of the diaphragm supports 102 in plan view, and a ring-shaped member 101 (actually having a rectangular shape and a circular hole) which insulates a guard ring 125c and a guard lead 125d from the substrate 100.

The lower conductive layer 120 joining the lower insulating film 110 and the upper insulating film 130 is a deposited film composed of polycrystal silicon entirely doped with impurities such as phosphorus (P), which is formed in a hatching area shown in FIG. 1. The lower conductive film 120 is used to form a guard member 127, which is constituted of guard electrodes 125a and guard connectors 125b as well as the guard ring 125c and the guard lead 125d, and a diaphragm 123.

The upper insulating film 130 (forming an insulating support layer) is a deposited film composed of silicon oxide having an insulating property. The upper insulating film 130 joins the lower conductive film 120, the upper conductive film 160, and the lower insulating film 110. The upper insulating film 130 is used to form a plurality of plate supports 131 which are aligned in a circumferential manner and inwardly of the diaphragm supports 102 in plan view, and a ring-shaped cover support (actually having a rectangular shape and a circular hole) 132 which supports a cover 161 and which insulates a plate lead 162d from the guard lead 125d. The cover support 132 is positioned externally of the plate supports 131 and the diaphragm supports 102. A ring-shaped interior surface 132a is formed in the cover support 132. The plate supports 131 are islands formed inside the ring-shaped interior surface 132a of the cover support 132. The thickness of the upper insulating film 130 is substantially identical to the thickness of a gap layer C3 which is defined between the plate 162 and the diaphragm 123 and which is surrounded by the ring-shaped interior surface 132a of the cover support 132. That is, the insulating support layer formed using the upper insulating film 130 is constituted of the plate supports 131 and the cover support 132, whereby the gap layer C3 having the predetermined thickness is formed between the lower conductive film 120 (forming the diaphragm 123 and the guard member 127) and the upper conductive film 160 (forming the plate 162 and the cover 161).

The upper conductive film 160 is a deposited film composed of polycrystal silicon entirely doped with impurities (such as P), which is positioned to overlap with the diaphragm 123 in plan view and which joins the upper insulating film 130. The upper conductive film 160 is used to form the plate 162 and the plate lead 162d (which is extended from the plate 162) as well as the cover 161 which is positioned to surround the plate 162 but is physically isolated from the plate 162 via slits. The cover 161 is formed using the deposited film forming the plate 162 but is electrically isolated from the plate 162.

The surface insulating film 170 joining the upper conductive film 160 and the upper insulating film 130 is a deposited film composed of silicon oxide having an insulating property.

The MEMS structure of the condenser microphone 1 has four terminals, i.e. 125e, 162e, 123e, and 10b, all of which are formed using a pad conductive film 180 (which is a deposited film composed of AlSi having a conductive property), a bump film 210 (which is a deposited film composed of Ni having a conductive property), and a bump protection film 220 (which is a deposited film composed of Au having a conductive property and high corrosion resistance. The side walls of the terminals 125e, 162e, 123e, and 100b are protected by a pad protection film 190 (which is a deposited film composed of SiN having an insulating property) and a surface protection film 200 (which is a deposited film composed of silicon oxide having an insulating property).

Next, the mechanical constitution of the MEMS structure of the condenser microphone 1 will be described in detail.

The diaphragm 123 is a single-layered deposited film entirely having a conductive property and is constituted of a center portion 123a and a plurality of arms 123c (which are extended externally from the center portion 123a in a radial manner). By the diaphragm supports 102 having pillar shapes joining with the external portion of the diaphragm 123 at prescribed positions, the diaphragm 123 is supported in parallel with the substrate 100 such that prescribed gaps are formed with the plate 162 and the substrate 100, wherein the diaphragm 123 is insulated from the plate 162. The diaphragm supports 102 are bonded to the distal ends of the arms 123c of the diaphragm 123. Due to cutouts formed between the arms 123c of the diaphragm 123, the diaphragm 123 is reduced in rigidity in comparison with the foregoing diaphragm not having arms. A plurality of diaphragm holes 123b is formed in each of the arms 123c, which is thus reduced in rigidity. Each of the arms 123c is gradually increased in breadth as it approaches to the center portion 123a of the diaphragm 123. This reduces the concentration of stress at boundaries between the arms 123c and the center portion 123a of the diaphragm 123. No bent portion is formed in the outline of each arm 123c in proximity to each of the boundaries between the arms 123c and the center portion 123a of the diaphragm 123; hence, it is possible to prevent stress from being concentrated at the bent portion.

The diaphragm supports 102 are aligned in the circumferential direction with equal spacing therebetween in the surrounding area of the opening 100a of the cavity C1. Each of the diaphragm supports 102 is formed by a deposited film having a pillar shape and an insulating property. The diaphragm 123 is supported above the substrate 100 by the diaphragm supports 102 such that the center portion 123a thereof covers the opening 100a of the back cavity C1 in plan view. A gap layer C2 whose thickness substantially corresponds to the thickness of the diaphragm supports 102 is formed between the substrate 100 and the diaphragm 123. The gap layer C2 is necessary to establish a balance between the internal pressure of the back cavity C1 and the atmospheric pressure. The gap layer C2 is reduced in height and is increased in length in the radial direction of the diaphragm 123 so as to form the maximum acoustic resistance in the path for transmitting sound waves (causing vibration of the diaphragm 123) toward the opening 100a of the back cavity C1.

A plurality of diaphragm bumps 123f is formed on the backside of the diaphragm 123 positioned opposite to the substrate 100. The diaphragm bumps 123f are projections which prevent the diaphragm 123 from being fixed to the substrate 100. They are formed using the waviness of the lower conductive film 120 forming the diaphragm 123. That is, dimples (or small recesses) are formed on the surface of the diaphragm 123 in correspondence with the diaphragm bumps 123f.

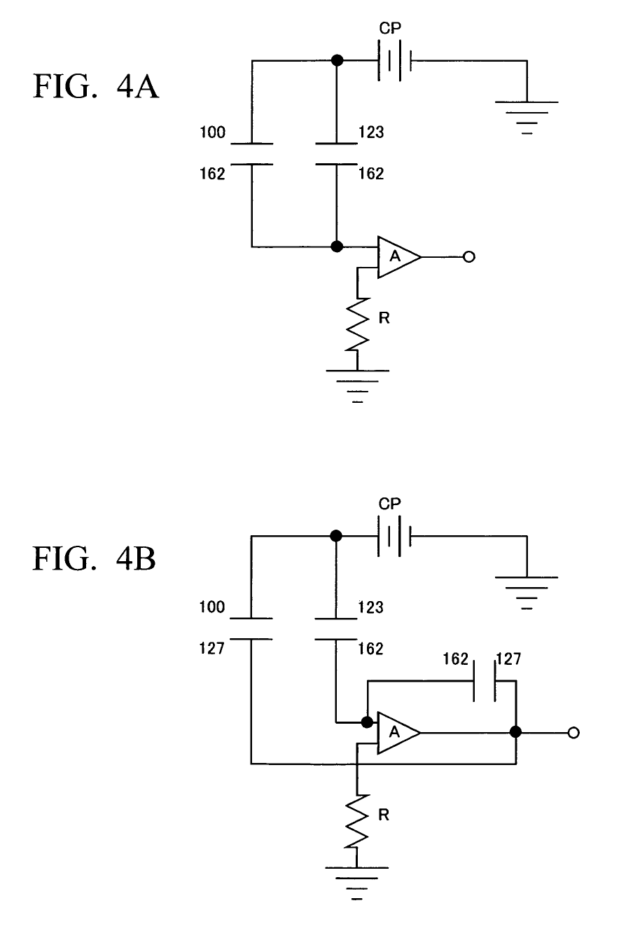

The diaphragm 123 is connected to the diaphragm terminal 123e via the diaphragm lead 123d which is elongated from the distal end of the prescribed arm 123c within the arms 123c. The width of the diaphragm lead 123d is smaller than the width of the arm 123c, wherein the diaphragm lead 123d is formed using the lower conductive film 120 in a similar manner to the diaphragm 123. The diaphragm lead 123d is elongated toward the diaphragm terminal 123e via a slit of the ring-shaped guard ring 125c. Since the diaphragm terminal 123e is short-circuited to the substrate terminal 100b via a circuit chip (not shown) as shown in FIGS. 4A and 4B, substantially the same potential is applied to both of the diaphragm 123 and the substrate 100.

When the potential of the diaphragm 123 differs from the potential of the substrate 100, parasitic capacitance may be formed between the diaphragm 123 and the substrate 100. Since the diaphragm 123 is supported by the diaphragm supports 102 having air layers therebetween, it is possible to reduce the parasitic capacitance in comparison with the foregoing structure in which the diaphragm is supported by the spacer having the ring-shaped wall structure.

The plate 162 is a single-layered deposited film entirely having a conductive property, wherein it is constituted of a center portion 162b and a plurality of joints (or arms) 162a which are extended externally from the center portion 162b in a radial direction. The plate 162 is supported by the plate supports 131 having pillar shapes joined with the joints 162a in such a way that a gap layer C3 is formed between the plate 162 and the diaphragm 123. Each of the plate supports 131 is positioned between the adjacent arms 123c of the diaphragm 123 in plan view. That is, the joints 162a of the plate 162 are supported by the plate supports 131 (forming the insulating support layer) at positions between the arms 123c of the diaphragm 123. In addition, the plate 162 is bridged across the plate supports 131 in parallel with the diaphragm 123 in such a way that the center of the plate 162 substantially matches the center of the diaphragm 123 in plan view. The distance between the center of the plate 162 (i.e. the center of the center portion 162b) and the periphery of the center portion 162b, i.e. the shortest distance between the center and the periphery of the plate 162, is shorter than the distance between the center of the diaphragm 123 (i.e. the center of the center portion 123a) and the periphery of the center portion 123a, i.e. the shortest distance between the center and the periphery of the diaphragm 123. Therefore, the plate 162 does not face the diaphragm 123 in the periphery of the diaphragm 123 which may vibrate with small amplitude. Due to the formation of cutouts between the joints 162a of the plate 162, the plate 162 does not face the diaphragm 123 in the cutouts which substantially match the periphery of the diaphragm 123 in plan view. The arms 123c are elongated in a radial direction from the center portion 123a of the diaphragm 123 in the cutouts of the plate 162 in plan view. This increases the distance between the terminal positions of vibration occurring in the diaphragm 123, i.e. the substantial distance of the diaphragm 123, without increasing the parasitic capacitance.

Numerous plate holes 162c are formed in the plate 162, wherein they collectively function as a passage for propagating sound waves toward the diaphragm 123 and as a through-hole for transmitting etchant for use in isotropic etching performed on the upper insulating film 130. The remaining portions of the upper insulating film 130 after etching form the plate supports 131 and the cover support 132, while the etched portion (or the removed portion) of the upper insulating film 130 forms the gap layer C3 between the diaphragm 123 and the plate 162. That is, the plate holes 162c are through-holes for transmitting etchant toward the upper insulating film 130 in order to simultaneously form the gap layer C3 and the plate supports 131. For this reason, the plate holes 162c are aligned in consideration of the height (or the thickness) of the gap layer C3 and the shapes of the plate supports 131 as well as the etching speed. Specifically, the plate holes 162c are formed and aligned with equal spacing therebetween in the overall area of the center portion 162b and the joints 162a except for the joint regions of the joints 162a joined with the plate supports 131. As the distance between the adjacent plate holes 162c gets smaller, the width of the cover support 132 (formed using the upper insulating film 130) gets smaller, thus reducing the overall chip area. The rigidity of the plate 162 decreases as the distance between the adjacent plate holes 162c gets smaller.

The plate supports 131 join the guard electrodes 125a which are positioned in the same layer as the diaphragm 123 and which are formed using the lower conductive layer 120 in a similar manner to the diaphragm 123. The plate supports 131 are each formed using the upper insulating film 130, which is a deposited film having an insulating property joining the plate 162. The plate supports 131 are aligned with equal spacing therebetween in the surrounding area of the opening 100a of the back cavity C1. Since the plate supports 131 are positioned in the cutouts between the arms 123c of the diaphragm 123 in plan view, it is possible to reduce the maximum diameter of the plate 162 to be smaller than the maximum diameter of the diaphragm 123. This increases the rigidity of the plate 162 while reducing the parasitic capacitance between the plate 162 and the substrate 100.

The plate 162 is supported above the substrate 100 by a plurality of pillar structures 129 which are constituted of the guard insulators 103, the guard electrodes 125a, and the plate supports 131. By means of the pillar structures 129, the gap layer C3 is formed between the plate 162 and the substrate 100, and the gap layers C2 and C3 are formed between the plate 162 and the substrate 100. Due to the insulating properties of the guard insulators 103 and the plate supports 131, the plate 162 is insulated from the substrate 100.

When the potential of the plate 162 differs from the potential of the substrate 100 due to the absence of the guard electrodes 125a, parasitic capacitance is formed in the prescribed region in which the plate 162 positioned opposite to the substrate 100, wherein the parasitic capacitance increases if other insulators are arranged therebetween (see FIG. 4A). The present embodiment is characterized in that the pillar structures 129 are formed using the guard insulators 103, the guard electrodes 125a, and the plate supports 131 and are physically separated from each other so as to support the plate 162 above the substrate 100, wherein even if the guard electrodes 125a are excluded from the preset embodiment, it is possible to reduce the parasitic capacitance in comparison with the foregoing structure in which the plate is supported above the substrate by the insulating member having the ring-shaped wall structure.

A plurality of plate bumps (i.e. projections) 162f is formed on the backside of the plate 162 positioned opposite to the diaphragm 123. The plate bumps 162f are formed using a silicon nitride (SiN) film joining the upper conductive layer 160 (forming the plate 162) and a polycrystal silicon film joining the silicon nitride film. The plate bumps 162f prevent the plate 162 from being fixed to the diaphragm 123. In order to avoid “stiction” (in which the plate 162 is fixed to the diaphragm 123, it is possible to form projections on the cover 161.

The plate lead 162d (whose width is smaller than the width of the joint 162a) is extended from the distal end of the prescribed joint 162a of the plate 162 toward the plate terminal 162e. The plate lead 162d is formed using the upper conductive film 160 in a similar manner to the plate 162. The wiring path of the plate lead 162d overlaps the wiring path of the guard lead 125d in plan view; thus, it is possible to reduce the parasitic capacitance between the plate lead 162d and the substrate 100.

The cover 161 having an inner gear-like shape (matching the gear-like shape of the plate 162) is formed to surround the plate 162. The internal outline of the cover 161, which is physically separated from the plate 162 via slits, is formed in conformity with the external outline of the plate 161. When slits between the cover 161 and the plate 162 get smaller in width, it becomes difficult for foreign matter to enter into the gap layer C3 between the plate 162 and the diaphragm 123. It is preferable that the widths of slits between the cover 161 and the plate 162 be smaller than the thickness of the gap layer C3 between the plate 162 and the diaphragm 123. Due to slits for physically separating the cover 161 from the plate 162, the cover 161 is physically separated from the plate lead 162d. That is, the periphery of the cover 161 is not completely ring-shaped but is divided at one position in the circumferential direction so as to form a slit, via which the plate lead 162d is extended toward the plate terminal 162e.

The cover 161 has a substantially ring-shaped external portion which joins the cover support 132. Projections 161a project inwardly from the cover 161 in the inside area defined by the ring-shaped interior surface 132a of the cover support 132, wherein they are positioned opposite to the periphery of the center portion 162b of the plate 162 via slits. That is, each of the projections 161a of the cover 161 which inwardly project in the inside area of the ring-shaped interior surface 132a of the cover support 132 has the maximum length allowing the distal end thereof to be extended close to the periphery of the center portion 162b of the plate 162. Recesses 161b are formed between the projections 161a of the cover 161 in the inside area of the ring-shaped interior surface 132a of the cover support 132, wherein they have depths whose bottoms are positioned opposite to the distal ends of the joints 162a of the plate 162 via slits. That is, each of the recesses 161b which are recessed in the inside area of the ring-shaped interior surface 132a of the cover support 132 has the minimum length allowing the bottom thereof to be recessed close to each of the distal ends of the joints 162a of the plate 162.

The cover 161 is supported by the cover support 132 which is formed using the upper insulating layer 130 in a similar manner to the plate supports 131. Thus, the gap layer C3 at predetermined thickness is formed between the plate 162 and the diaphragm 123 as well as between the cover 161 and the diaphragm 123.

The cover 161 is positioned opposite to the arms 123c of the diaphragm 123 in plan view, wherein no parasitic capacitance is formed therebetween because the cover 161 is electrically isolated from the plate 162 via slits so that the cover 161 is sustained in an electrically floating state.

A plurality of cover holes 161c is formed in the cover 161 in order to form the gap layer C3 between the cover 161 and the diaphragm 123. The cover holes 161c are through-holes for transmitting etchant used for etching of the upper insulating layer 130; that is, they are through-holes that transmit etchant toward the upper insulating layer 130 in order to simultaneously form the gap layer C3 and the cover support 132. The number of the cover holes 161c should be determined to achieve the formation of the gap layer C3 between the cover 161 and the diaphragm 123, wherein each of the cover holes 161c is formed in a prescribed shape for reliably transmitting etchant therethrough. The cover holes 161c are formed not to cause deviations of alignment density in a certain area of the cover 161 positioned just above the diaphragm 123. The cover holes 161c are aligned in consideration of the height (or thickness) of the gap layer C3 and the shape of the cover support 132 as well as the etching speed. Specifically, the cover holes 161c are formed in substantially the overall area of the cover 161 with equal spacing therebetween except for the joint area of the cover 161 joining the cover support 132 and its surrounding area. As the distance between the adjacent cover holes 161c gets smaller, it is possible to reduce the width of the cover support 132, thus reducing the overall chip area.

Next, the operation of the condenser microphone 1 will be described with reference to FIGS. 4A and 4B, each of which shows an equivalent circuit regarding the sensor chip and the circuit chip connected together.

A charge pump CP installed in the circuit chip applies a stable bias voltage to the diaphragm 123. The sensitivity of the condenser microphone 1 becomes higher as the bias voltage becomes higher, wherein the diaphragm 123 may be easily fixed to the plate 162; hence, the rigidity of the plate 162 is a significant factor in designing the condenser microphone 1.

Sound waves entering into a through-hole of a package (not shown) are transmitted to the diaphragm 123 via the plate holes 162c and the cutouts between the joints (or arms) 162a of the plate 162. Since sound waves of the same phase are propagated on both the surface and the backside of the plate 162, the plate 162 does not vibrate substantially. Sound waves transmitted to the diaphragm 123 make the diaphragm 123 vibrate relative to the plate 162. The vibration of the diaphragm 123 varies the electrostatic capacitance of a parallel-plate condenser (including opposite electrodes corresponding to the plate 162 and the diaphragm 123). Variations of electrostatic capacitance are converted into voltage signals, which are then amplified by an amplifier A installed in the circuit chip.

Since the diaphragm 123 is short-circuited to the substrate 100, a parasitic capacitance is formed between the substrate 100 and the plate 162 (which is not vibrate relatively) in the circuitry of FIG. 4A which does not include the guard member 127 and the guard electrode 125. In the circuitry of FIG. 4B, a voltage-follower circuit is formed by the amplifier A whose output terminal is connected to the guard member 127, thus avoiding the occurrence of the parasitic capacitance between the plate 162 and the substrate 100. That is, the guard electrodes 125a are inserted between the substrate 100 and the joints 162a of the plate 162 in the prescribed areas (in which they are positioned opposite to each other), thus reducing the parasitic capacitance between the substrate 100 and the joints 162a of the plate 162. In addition, the guard lead 125d (which is extended from the guard ring 125c for connecting the guard electrodes 125a to the guard terminal 125e) is wired in the same region as the plate lead 162d (which is extended from the joint 162a of the plate 162) in plan view, thus avoiding the occurrence of a parasitic capacitance between the substrate 100 and the plate lead 162d. The guard ring 125c connects the guard electrodes 125a together with the shortest paths therebetween in the surrounding area of the diaphragm 123. Since the breadths of the guard electrodes 125a are larger than the breadths of the joints 162a in the circumferential direction of the plate 162, it is possible to further reduce the parasitic capacitance.

In this connection, the above elements such as the charge pump CP and the amplifier A (installed in the circuit chip) can be installed in the sensor chip, thus forming the condenser microphone 1 having a single chip structure.

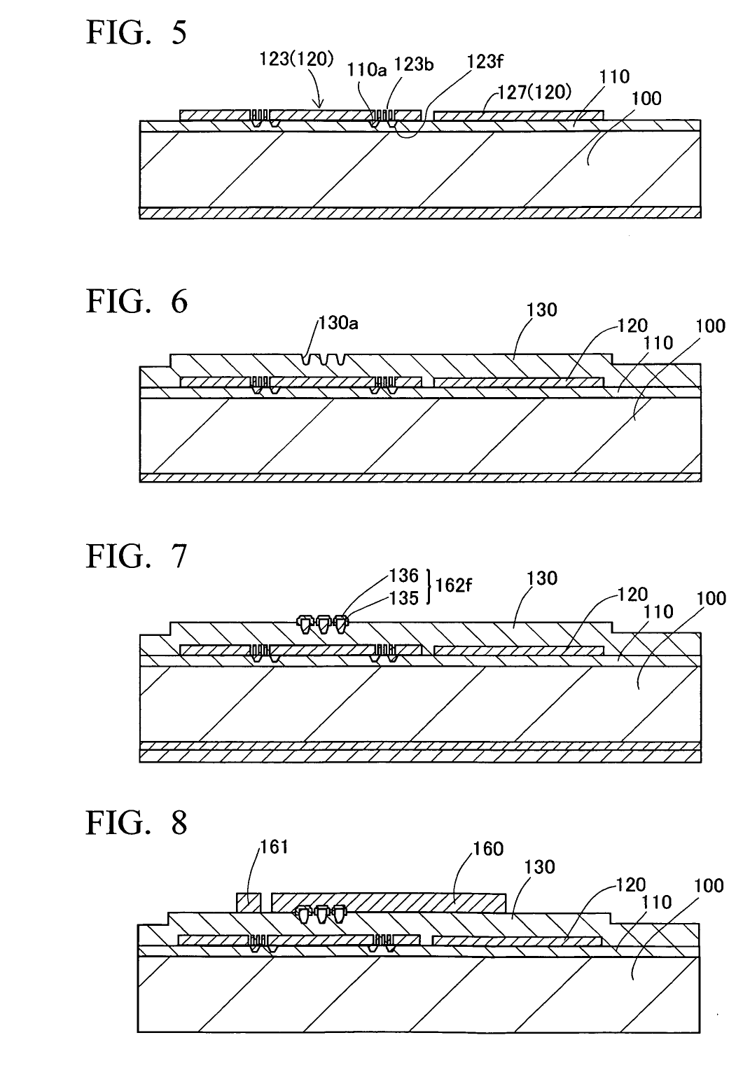

Next, the manufacturing method of the condenser microphone 1 will be described in detail with reference to FIGS. 5 to 17.

In a first step of the manufacturing method shown in FIG. 5, the lower insulating film 110 composed of silicon oxide is formed on the entire surface of the substrate 100. The dimples 110a (which are used for the formation of the diaphragm bumps 123f) are formed in the lower insulating film 110 by way of etching using a photoresist mask. The lower conductive film 120 composed of polycrystal silicon is formed on the surface of the lower insulating film 110 by way of chemical vapor deposition (CVD), thus forming the diaphragm bumps 123f below the dimples 110a. Then, the lower conductive film 120 is etched using a photoresist mask, thus forming the diaphragm 123 and the guard member 127 (both of which are composed of the lower conductive film 120).

In a second step of the manufacturing method shown in FIG. 6, the upper insulating film 130 composed of silicon oxide is formed entirely on the surfaces of the lower insulating film 110 and the lower conductive film 120. Then, dimples 130a (which are used for the formation of the plate bumps 162f) are formed in the upper insulating film 130 by way of etching using a photoresist mask.

In a third step of the manufacturing method shown in FIG. 7, the plate bumps 162f, which are composed of a polycrystal silicon film 135 and a nitride silicon film 136, are formed on the surface of the upper insulating film 130. Since the silicon nitride film 136 is formed after the patterning of the polycrystal silicon film 135 by way of a known method, the exposed portions of the polycrystal silicon film 135 which project from the dimples 130a are entirely covered with the silicon nitride film 136. The silicon nitride film 136 is an insulating film for preventing the diaphragm 123 from being short-circuited to the plate 162 even when the diaphragm 123 is unexpectedly fixed to the plate 162.

In a fourth step of the manufacturing method shown in FIG. 8, the upper conductive film 160 composed of polycrystal silicon is formed on the surface of the upper insulating film 130 and the exposed surfaces of the silicon nitride film 136 by way of CVD. Then, the upper conductive film 160 is etched using a photoresist mask so as to form the plate 162, the plate lead 162d, and the cover 161. In this step, the plate holes 162c and the cover holes 161c are not formed.

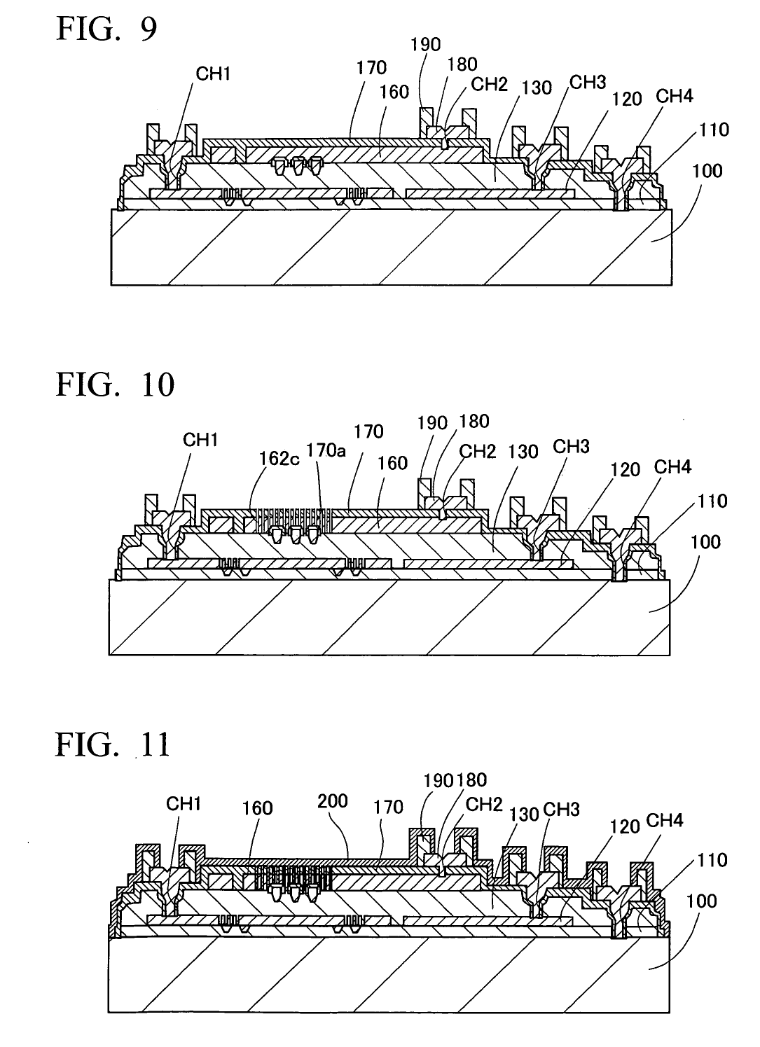

In a fifth step of the manufacturing method shown in FIG. 9, contact holes CH1, CH3, and CH4 are formed in the upper insulating film 130, and then the surface protection film 170 composed of silicon oxide is formed on the entire surface. In addition, etching using a photoresist mask is performed so as to form a contact hole CH2 in the surface insulating film 170 and to simultaneously remove the remaining portions of the surface insulating film 170 remaining in the bottoms of the contact holes CH1, CH3, and CH4. The pad conductive film 180 composed of AlSi is formed and is embedded in the contact holes CH1, CH2, CH3, and CH4; then, it is removed by way of a known method while leaving the prescribed portions thereof remaining in the contact holes CH1, CH2, CH3, and CH4. Subsequently, the pad protection film 190 composed of silicon nitride is formed on the surface insulating film 170 and the pad conductive film 180 by way of CVD; then, it is subjected to patterning by way of a known method, thus leaving the prescribed portion thereof in the surrounding area of the pad conductive film 180.

In a sixth step of the manufacturing method shown in FIG. 10, anisotropic etching is performed using a photoresist mask so as to form through-holes 170a (corresponding to the plate holes 162c and the cover holes 161c, wherein the cover holes 161c are not shown in FIGS. 10 to 17) in the surface insulating film 170, whereby the plate holes 162c are formed in the upper conductive film 160 while the cover holes 161c are formed in the cover 161. This step is performed consecutively, wherein the surface insulating film 170 having the through-holes 170a is used as a resist mask for the upper conductive film 160.

In a seventh step of the manufacturing method shown in FIG. 11, the surface protection film 200 is formed on the surfaces of the surface insulating film 170 and the pad protection film 190. At this time, all the through-holes 170a of the surface insulating film 170 as well as the plate holes 162c and the cover holes 161c are embedded below the surface protection film 200.

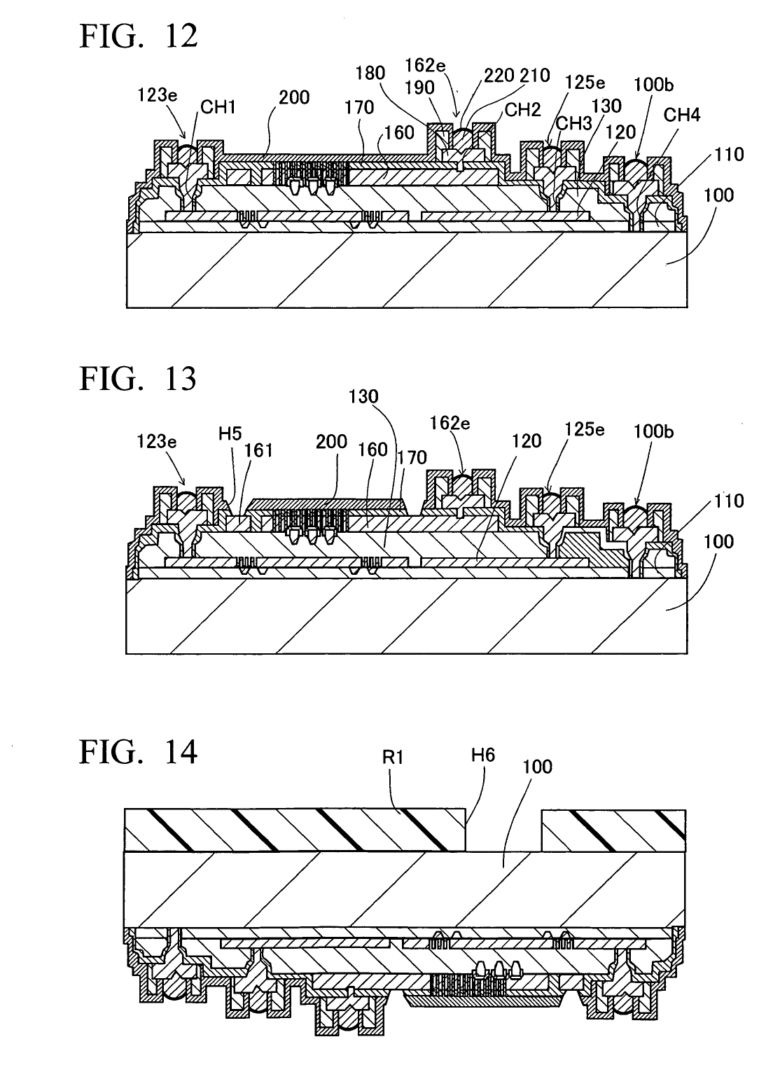

In an eighth step of the manufacturing method shown in FIG. 12, the bump film 210 composed of Ni is formed on the surface of the pad conductive film 180 which still remains in the contact holes CH1, CH2, CH3, and CH4, and then the bump protection film 220 composed of Au is formed on the surface of the bump film 210. In this step, the backside of the substrate 100 is polished so as to make the substrate 100 have a predetermined thickness (substantially matching product dimensions).

In a ninth step of the manufacturing method shown in FIG. 13, etching is performed using a photoresist mask so as to form a through-hole H5 by which the cover 161 is partially exposed from the surface protection film 200 and the surface insulating film 170.

The above steps complete the film formation process with respect to the surface of the substrate 100.

In a tenth step of the manufacturing method shown in FIG. 14 (which is executed after completion of the film formation process on the surface of the substrate 100), a photoresist mask R1 having a through-hole H6 (used for the formation of the through-hole corresponding to the back cavity C1 in the substrate 100) is formed on the backside of the substrate 100.

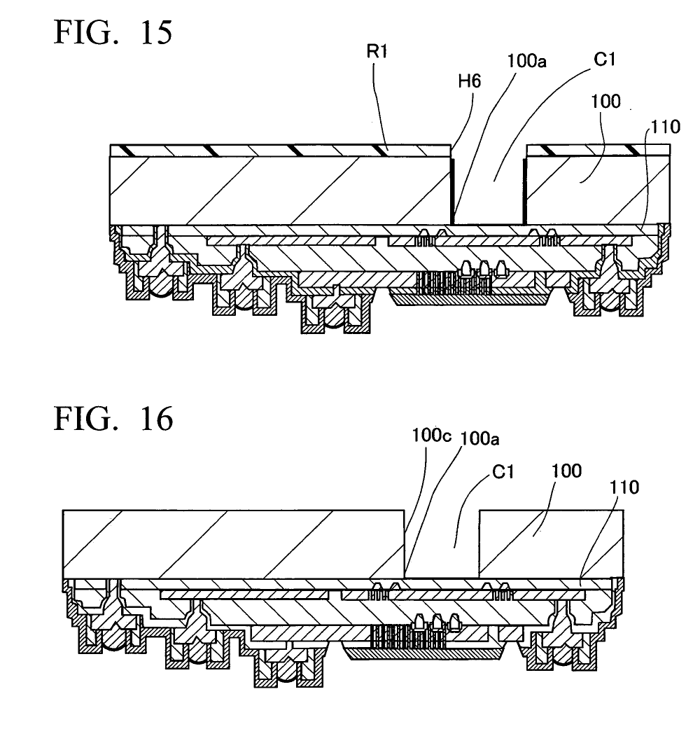

In an eleventh step of the manufacturing method shown in FIG. 15, Deep Reactive Ion Etching (Deep-RIE) is performed on the substrate 100 so as to form the through-hole. At this time the lower insulating film 110 serves as an etching stopper.

In a twelfth step of the manufacturing method shown in FIG. 16, the photoresist mask R1 is removed from the substrate 100, and then an interior wall 100c of the through-hole (which is formed with roughness due to Deep-RIE) is smoothed.

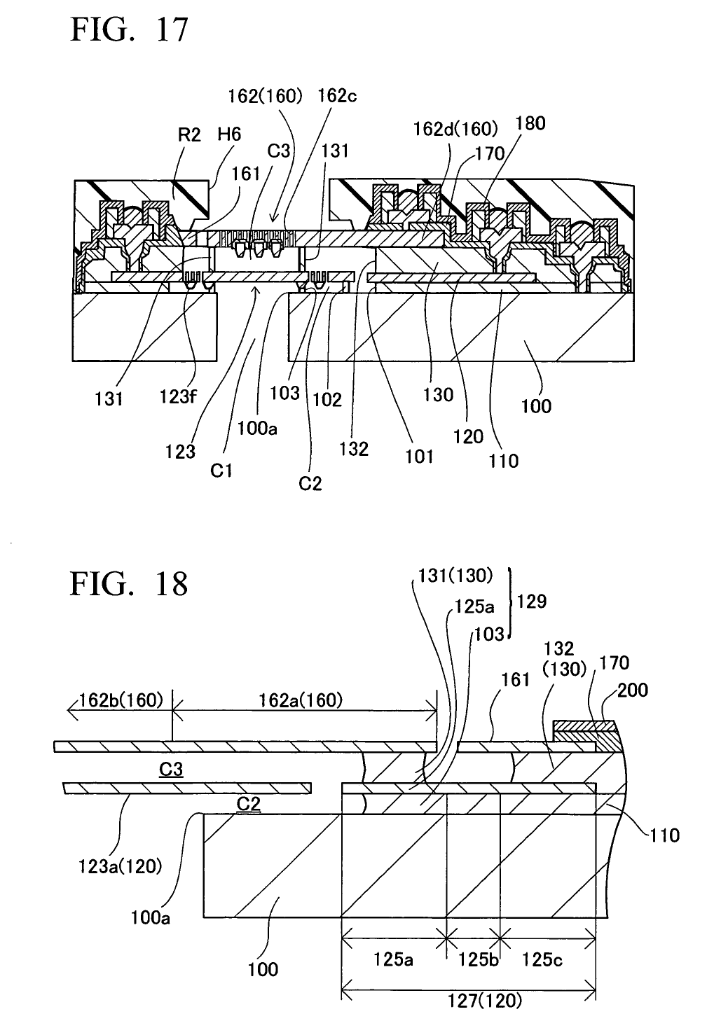

In a thirteenth step of the manufacturing method shown in FIG. 17, isotropic etching is performed using a photoresist mask R2 and buffered hydrofluoric acid (BHF) so as to remove the surface protection film 200 and the surface insulating film 170 from the plate 162 and the plate lead 162d. In addition, the upper insulating film 130 is partially removed so as to form the cover support 132, the plate supports 131, and the gap layer C3. Furthermore, the lower insulating film 110 is partially removed so as to form the guard insulators 103, the diaphragm supports 102, the ring-shaped member 101, and the gap layer C2. At this time, an etchant of BHF enters into the through-hole H6 of the photoresist mask R2 and the opening 100a of the substrate 100. The etchant (entering into the through-hole H6 of the photoresist mask R2 and the opening 100a of the substrate 100) is transmitted through the slits between the plate 162 and the cover 161, the plate holes 162c, and the cover holes 161c so as to etch the upper insulating film 160. The outline of the upper insulating film 130 is defined by the plate 162 and the plate lead 162d. That is, the cover support 132 and the plate supports 131 are formed by way of the self-alignment of the plate 162 and the plate lead 162d. As shown in FIG. 18, undercuts are formed on the terminal surfaces of the cover support 132 and the plate supports 131 by isotropic etching. The outline of the lower insulating film 110 is defined by the opening 100a of the substrate 100, the diaphragm 123, the diaphragm lead 123d, the guard electrodes 125a, the guard connectors 125b, and the guard ring 125c. That is, the guard insulators 103 and the diaphragm supports 102 are formed by way of the self-alignment of the diaphragm 123. As shown in FIGS. 18 and 19, undercuts are formed on the terminal surfaces of the guard insulators 103 and the plate supports 131 by isotropic etching. Both of the guard insulators 103 and the plate supports 131 are formed in this step, thus forming the pillar structures 129 (for supporting the plate 162 above the substrate 100) except for the guard electrodes 125a.

Lastly, the photoresist mask R2 is removed from the substrate 100, which is then subjected to dicing. This completes the production of the sensor chip of the condenser microphone 1 shown in FIG. 1. The sensor chip and the circuit chip are attached to a package substrate (not shown), in which the terminals thereof are connected together via wire bonding; then, a package cover (not shown) is placed above the package substrate, thus completing the production of the condenser microphone 1. Since the sensor chip is bonded onto the package substrate, the back cavity C1 is closed in an airtight manner in the backside of the substrate 100.

The first embodiment is illustrative and not restrictive; hence, it can be modified in various manners. For example, it is unnecessary for the slit between the plate 162 and the cover 161 to have fixed dimensions in width; that is, the slit can be partially broadened in width. In addition, it is unnecessary for the slit to be integrally connected between the plate 162 and the cover 161. As shown in FIG. 20, it is possible to modify the cover 161 to have an interior space (defined by a polygonal interior surface or a circular interior surface) for entirely installing the plate 162 having a gear-like shape therein, wherein the cover 161 inwardly projects from the ring-shaped interior surface 132a of the cover support 132 in plan view. In this modification, the center portion 162b of the plate 162 is distanced from the interior surface of the cover 161 without any slits therebetween, while the distal ends of the joints (or arms) 162a of the plate 162 are positioned close to the interior surface of the cover 161 with slits therebetween.

### 2. Second Embodiment

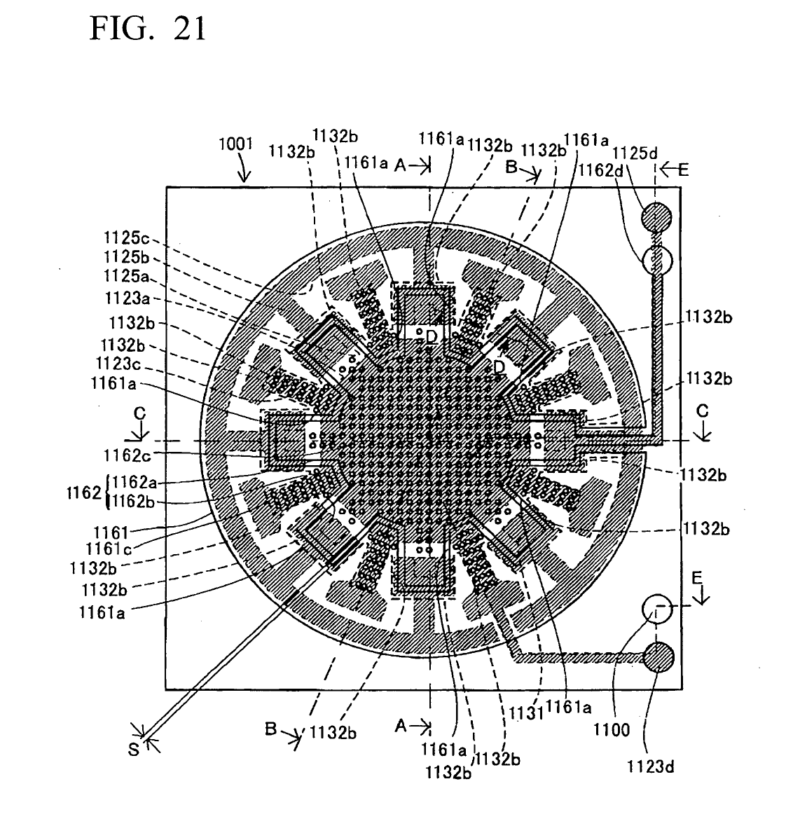

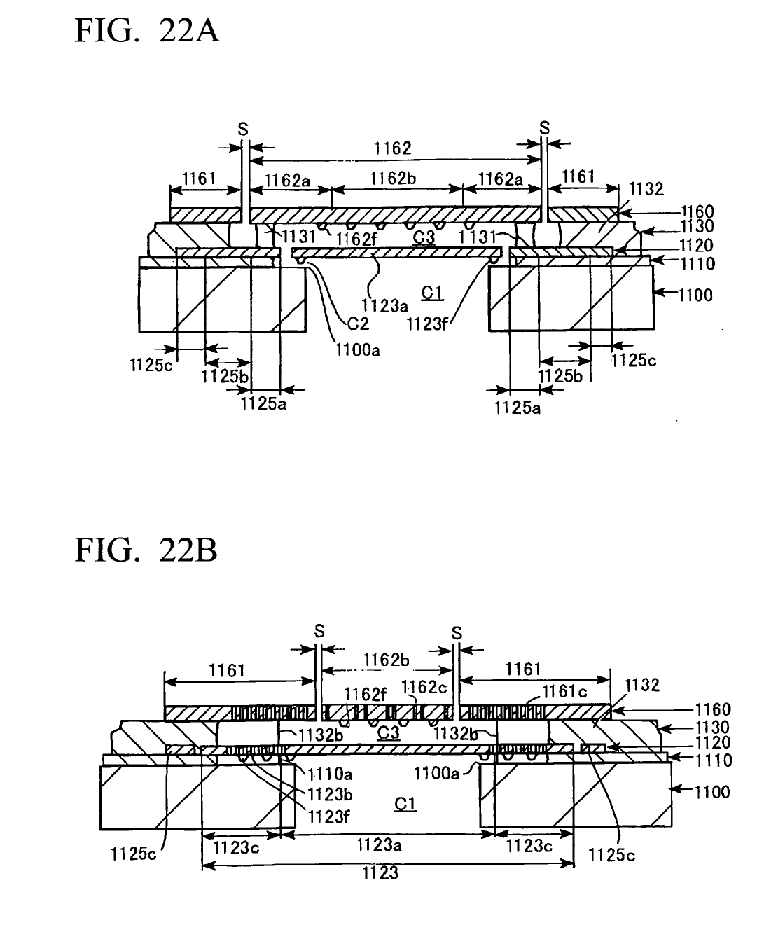

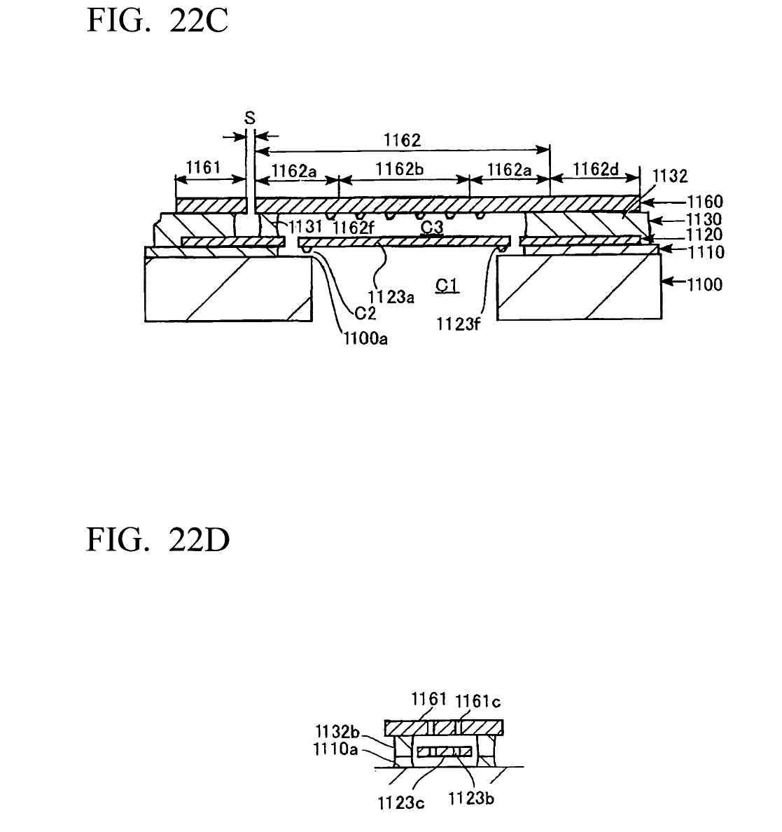

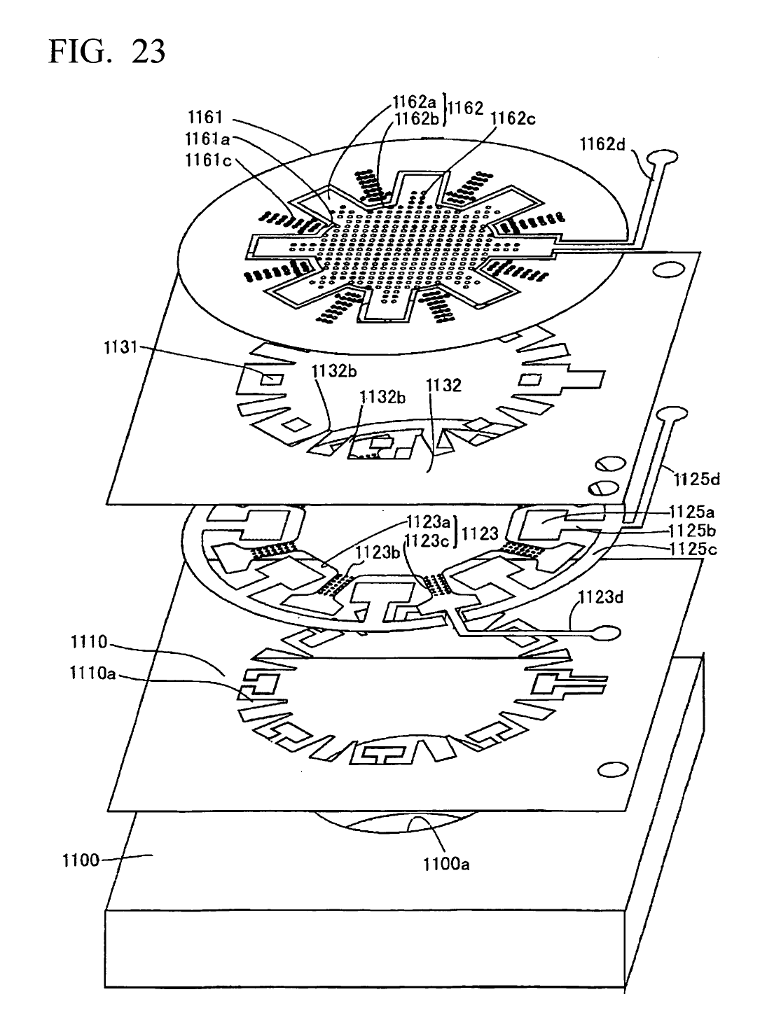

FIG. 21 shows the constitution of a sensor die 1001, which is a solid element of a condenser microphone, i.e. a pressure transducer, in accordance with a second embodiment of the present invention. FIG. 22A to 22D shows cross sections of the sensor die 1001, wherein FIG. 22A is a sectional view taken along line A-A in FIG. 21, FIG. 22B is a sectional view taken along line B-B in FIG. 21, FIG. 22C is a sectional view taken along line C-C in FIG. 21, and FIG. 22D is a sectional view taken along line D-D in FIG. 21. FIG. 23 is an exploded perspective view showing the lamination structure of the sensor die 1001. The condenser microphone is constituted of the sensor die 1001, a circuit die (not shown) including a power circuit and an amplifier, and a package (not shown) having a space for storing the sensor die 1001 and the circuit die and a through-hole for propagating sound pressures to the sensor die 1001.

First, films and layers constituting the sensor die 1001 of the condenser microphone will be described below.

The sensor die 1001 is an solid element constituted of a substrate 1100, a lower insulating film 1110 (laminated on the substrate 1100), a lower conductive film 1120, an upper insulating film 1130, and an upper conductive film 1160. FIGS. 21, 22A-22C, and 23 do not include illustrations regarding other layers formed above the upper conductive film 1160.

The substrate 1100 is composed of P-type monocrystal silicon (Si); but this is not a restriction. That is, the substrate 1100 can be composed of other materials satisfying mechanical properties serving as bases for depositing thin films and for supporting structures including thin films. The thickness of the substrate 1100 is set to 625 μm, for example. The lower insulating film 1110 is a deposited film composed of silicon oxide (SiOx), wherein the thickness thereof ranges from 1.5 μm to 2.0 μm, for example. The lower conductive film 1120 is a deposited film composed of polycrystal silicon entirely doped with impurities such as phosphorus (P), wherein the lower conductive film 1120 is formed in hatching areas in FIG. 21 and the thickness thereof ranges from 0.5 μm to 0.7 μm, for example. The upper insulating film 1130 is an “insulating” deposited film composed of silicon oxide, wherein the thickness thereof ranges from 4.0 μm to 5.0 μm, for example. The upper conductive film 1160 is a deposited film composed of polycrystal silicon entirely doped with impurities such as phosphorus, wherein the thickness thereof ranges from 1.0 μm to 2.0 μm, for example.

Next, the mechanical structure of the sensor die 1001 of the condenser microphone will be described below.

A through-hole having an opening 1100a is formed in the substrate 1100, wherein the opening 1100a serves as the opening of a back cavity C1 as well. The opposite side of the back cavity C1, which is opposite to the opening 1100a, is closed by the package (not shown). That is, the opposite side of the back cavity C1 does not substantially propagate sound waves therethrough. The substrate 1100 substantially serves as a rigid material compared to a “flexible” diaphragm 1123.

The diaphragm 1123 is formed using the lower conductive film 1120 having a small thickness and flexibility compared to the substrate 1100, wherein it is constituted of a center portion 1123a (for receiving pressure) and a plurality of arms (or bands) 1123c. The diaphragm 1123 is fixed in parallel with the surface of the substrate 1100 at the position at which the center portion 1123a thereof covers the opening 1100a of the substrate 1100. The center portion 1123a of the diaphragm 1123 has a circular shape or a polygonal shape in plan view so as to cover the opening 1100a of the substrate 1100 and its surrounding area. The arms 1123c of the diaphragm 1123 are elongated in a radial direction within the plane parallel to the surface of the substrate 1100. The distal ends of the arms 1123c are each enlarged in a hammerhead-like shape, wherein they are sandwiched between the lower insulating film 1110 and the upper insulating film 1130 and are thus connected to the lower insulating film 1110 and the upper insulating film 1130. Since the lower insulating film 1110 is connected to the substrate 1100, the distal ends of the arms 1123c are indirectly fixed to the substrate 1100 via the lower insulating film 1110. Hereinafter, the other portions of the arms 1123c which are not brought into contact with the lower insulating film 1110 and the upper insulating film 1130 will be referred to as flexible portions. The arms 1123c adjoin together with cutouts therebetween while the distal ends of the arms 1123c are fixed in position, whereby, compared to the foregoing diaphragm (having a circular shape or a polygonal shape) whose circumferential periphery is entirely fixed in position, the diaphragm 1123 may be easily deformed. Numerous diaphragm holes 1123b are formed in the arms 1123c, which are thus reduced in rigidity.

A gap layer C2 whose height is identical to the thickness of the lower insulating film 1110 is formed between the edge of the opening 1100a of the substrate 1100 and the center portion 1123a of the diaphragm 1123. The gap layer C2 serves as a passage for establishing a balance between the internal pressure of the back cavity C1 and the atmospheric pressure. In addition, the gap layer C2 forms the maximum acoustic resistance in the path which propagates sound waves entering into the package via its through-hole toward the opening 1100a of the back cavity C1. A plurality of diaphragm bumps 1123f is formed on the backside of the diaphragm 1123 facing the substrate 1100. The diaphragm bumps 1123f are projections that prevent the diaphragm 1123 from being fixed to the substrate 1100.

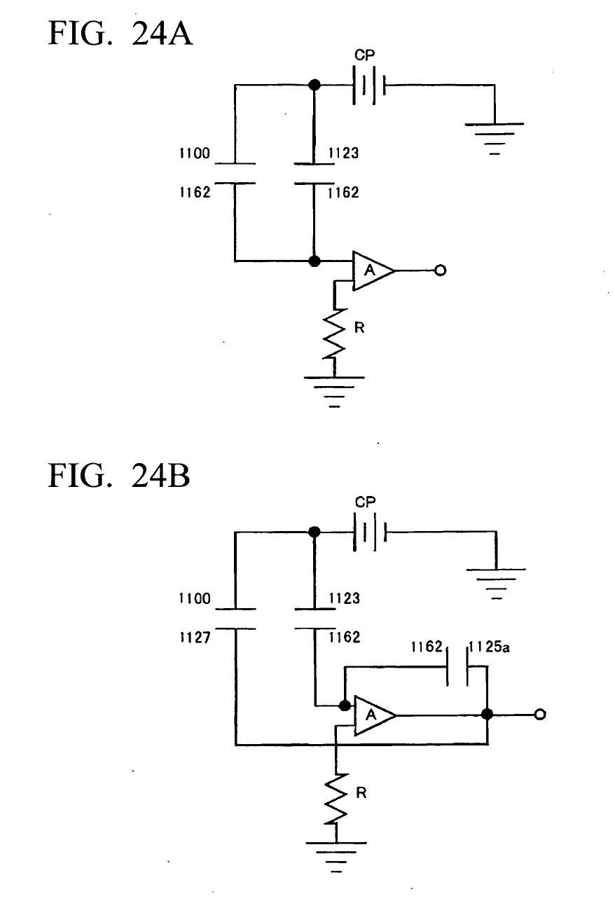

The diaphragm 1123 is connected to a diaphragm terminal (not shown) via a diaphragm lead 1123d which is extended from prescribed one of the arms 1123c. The diaphragm lead 1123 is extended toward the diaphragm terminal via a cutout of a guard ring 1125c. Since the diaphragm 1123 is short-circuited to the substrate 1100 via the circuit die (not shown) as shown in FIG. 24B, the same potential is set to both the diaphragm 1123 and the substrate 1100.

The plate 1162 is formed using the upper conductive film 1160 which is thicker than the lower conductive film 1120, wherein the plat 1162 is constituted of a center portion 1162b and a plurality of joints (or arms) 1162. Numerous plate holes 1162c are formed in the plate 1162. The plate holes 1162c serve as through-holes for propagating sound waves toward the diaphragm 1123. The center portion 1162b of the diaphragm 1162 has a circular shape or a polygonal shape, which is positioned opposite to the center portion 1123a of the diaphragm 1123 so as to entirely cover it in plan view. The joints 1162a are elongated in a radial direction from the center portion 1162b in parallel with the surface of the substrate 1100. In a viewing direction perpendicular to the surface of the substrate 1100 as shown in FIGS. 1 and 3, the joints 1162a of the plate 1162 are positioned in connection with the arms 1123c of the diaphragm 1123 in such a way that the joints 1162a do not overlap with the arms 1123c and are positioned alternately with the arms 1123c in plan view, hence, the arms 1123c are positioned just below the cutouts formed between the joints 1162a adjoining together in the circumferential direction of the center portion 1162b of the plate 1162. The distal ends of the joints 1162a are fixed to the substrate 1100 by way of plate supports 1131 which are formed using the upper insulating film 1130 in islands, guard electrodes 1125a which are formed using the lower conductive layer 1120, and the lower insulating film 1110. In a viewing direction perpendicular to the surface of the substrate 1100, the plate 1162 is fixed in parallel with the surface of the substrate 1100 at the position at which the center portion 1162b overlaps with the opening 1100a of the substrate 1100 in plan view. A gap layer C3 whose thickness is identical to the heights of the plate supports 1131 is formed between the plate 1162 and the diaphragm 1123. In a viewing direction perpendicular to the surface of the substrate 1100, the plate supports 1131 are positioned in the cutouts formed between the arms 1123c adjoining together in proximity to the center portion 1123a rather than the distal ends of the arms 1123c, which are fixed to the substrate 1100, in plan view. This increases the rigidity of the plate 1162. A plurality of plate bumps 1162f are formed on the backside of the plate 1162 facing the diaphragm 1123. The plate bumps 1162f are projections which prevent the diaphragm 1123 from being fixed to the plate 1162. A plate lead 1162d which is thinner than the joint 1162a is extended from prescribed one of the distal ends of the joints 1162a of the plate 1162 toward a plate terminal (not shown). The plate lead 1162d is formed using the upper conductive film 1160 in a similar manner to the plate 1162. In a viewing direction perpendicular to the surface of the substrate 1100, the wiring path of the plate lead 1162d overlaps the wiring path of a guard lead 1125d in plan view.

As shown in FIG. 22B, a cover 1161 composed of the upper conductive layer 1160 is supported above the substrate 1100 in view of the diaphragm 1123 via a cover support 1132 and the lower insulating film 1110. As show in FIGS. 21 and 22A-22C, the cover 1161 is physically separated from the plate 1162 via a slit S. That is, the plate 1162 and the cover 1161 both composed of the upper conductive film 1160 are insulated from each other via the slit S. The internal outline of the cover 1161 is formed along the outline of the plate 1162. A plurality of projections 1161a are formed integrally with the cover 1161 so as to project inwardly toward the center portion 1162b of the plate 1162 in the cutouts formed between the joints 1162a in plan view. The width of the slit S is set to a prescribed value for preventing foreign matter from entering into the gap layer C3 between the plate 1162 and the diaphragm 1123. The cover 1161 is split in one region in the circumferential direction thereof, hence, the plate lead 1162d is extended via the split region of the cover 1161.

As shown in FIGS. 21 and 22B, the projections 1161a of the cover 1161 project toward the center portion 1162b so as to cover the flexible portions of the arms 1123c of the diaphragm 1123 in plan view. As shown in FIGS. 21 and 22D, in a viewing direction parallel to the surface of the substrate 1100, the projections 1161a of the cover 1161 are supported by projections 1132b, which project inwardly from the cover support 1132 (see FIG. 23), on both sides thereof in prescribed regions which is closer to the center portion 1123a of the diaphragm 1123 than the distal ends of the arms 1123c. That is, the projections 1161a of the cover are supported by the projections 1132b of the cover support 1132 in such a way that they do not come in contact with the flexible portions of the arms 1123c of the diaphragm 1123 by being deformed due to external force or stress. The projections 1161a of the cover 1161 are fixed at higher positions than the arms 1123c of the diaphragm 1123 on the basis of the surface of the substrate 1100. A height h of a gap (i.e., a vertical length measured in a perpendicular direction to the surface of the substrate 1100) formed between the cover 1161 and the arms 1123c of the diaphragm 1123 is significantly larger than prescribed amplifications defined for the flexible portions of the arms 1123c of the diaphragm 1123.

The cover support 1132 is formed using the upper insulating film 1130. As shown in FIGS. 22B and 22D, the projections 1132b of the cover support 1132 join the backsides of the projections 1161a of the cover 1161, and a plurality of projections 1110a are formed integrally and inwardly of the lower insulating film 1110 (see FIG. 23) in correspondence with the projections 1132b of the cover support 1132. The projections 1132b of the cover support 1132 are fixed to the substrate 1100 via the projections 1110a of the lower insulating film 1110. That is, the projections 1161a of the cover 1161 are supported above the substrate 1110 via double-layered wall structures constituted of the projections 1132b of the cover support 1132 and the projections 1110a of the lower insulating film 1110. The cover 1161 for covering the arms 1123c supported by the lower insulating film 1110 is supported by the lower insulating film 1110 and the upper insulating film 1130.

A space surrounded by the substrate 1100, the projections 1161a of the cover 1161, and the double-layered wall structures (constituted of the projections 1132b of the cover support 1132 and the projections 1110a of the lower insulating layer 1110) forms a traverse hole having a rectangular parallelepiped shape and an opening positioned close to the center portion 1123a of the diaphragm 1123, wherein the distal ends of the arms 1123c of the diaphragm 1123 are fixed to the innermost recess of the traverse hole in the view of the opening 1110a. As described above, the distal ends of the arms 1123c of the diaphragm 1123 are fixed in position by being tightly held between the upper insulating film 1130 (forming the cover support 1132) and the lower insulating film 1110. As shown in FIG. 22D, the flexible portions of the arms 1123 are stored in the traverse hole and are surrounded by the substrate 1100, the projections 1161a of the cover 1161, and the double-layered wall structures (which are constituted of the projections 1132b of the cover support 1132 and the projections 1110a of the lower insulating film 1110). As shown in FIG. 22D, the flexible portions of the arms 1123c are physically separated from the substrate 1100, the projections 1161a of the cover 1161, and the double-layered wall structures (constituted of the projections 1132b and 1110a).

The gaps between the adjacent projections 1132b of the cover support 1132 are formed in a self-alignment manner by way of etching which is performed on the upper insulating film 1130 by use of an etchant supplied via the cover holes 1161c of the cover 1161, wherein they are defined by the shape and alignment of the cover holes 1161c. The gaps between the projections 1110a of the lower insulating film 1110 are formed in a self-alignment manner by way of etching which is performed o the lower insulating film 1110 by use of an etchant supplied via the diaphragm holes 1123b of the arms 1123c of the diaphragm 1123, wherein they are defined by the shape and alignment of the diaphragm holes 1123c.

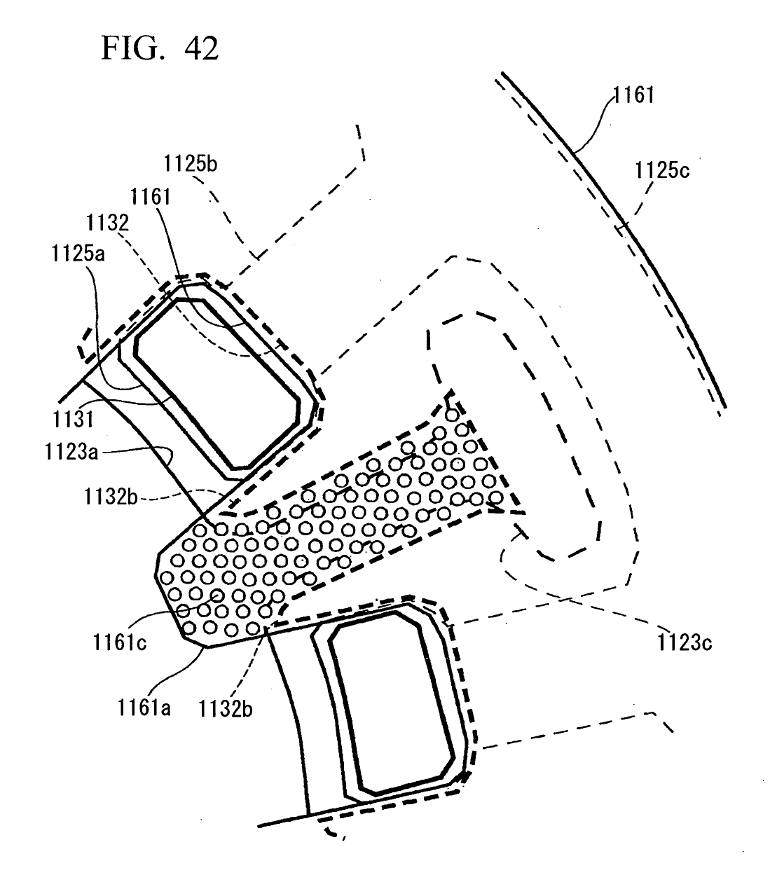

FIG. 42 shows an example of the shape and alignment of the cover holes 1161c. FIG. 42 is a plan view of the sensor die 1001, which is observed in a perpendicular direction to the diaphragm 1123 without illustrating the plate 1162. The cover holes 1161c are aligned in the prescribed region of the cover 1161 positioned opposite to the center portion 1123a of the diaphragm 1123 and the flexible portions of the arms 1123c. Substantially the same distance is set between the centers of the cover holes 1161c adjoining together. That is, the cover holes 1161c are aligned uniformly in the cover 1161 in proximity to the distal ends of the projections 1161a positioned opposite to the center portion 1123a of the diaphragm 1123. The prescribed region for aligning the cover holes 1161c is reduced in width to be smaller than the width of the projection 1161a (in the circumferential direction) in a direction from the distal end to the base portion of the projection 1161a. The projections 1132b of the cover support 1132 are formed beneath the side areas of the prescribed region which do not form the cover holes 1161c in the projection 1161a of the cover 1161. The width of the prescribed region for aligning the cover holes 1161c in the projection 1161a of the cover 1161 is larger than the width of the flexible portion of the arm 1123c of the diaphragm 1123. This forms a sufficiently large gap between the cover support 1132 and the flexible portions of the arms 1123c of the diaphragm 1123.

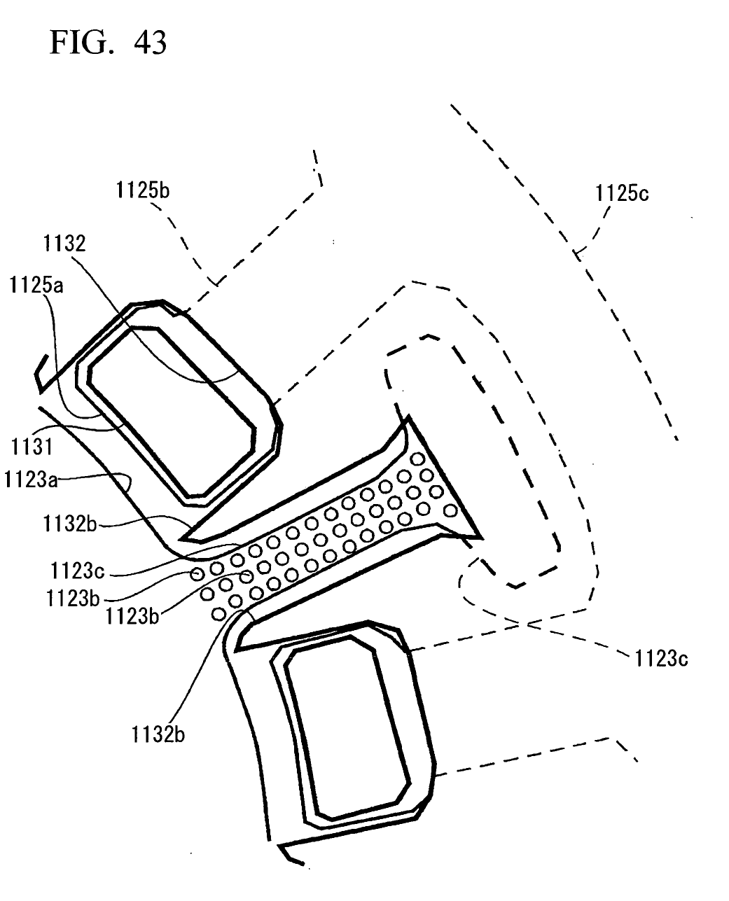

FIG. 43 shows an example of the shape and alignment of the diaphragm holes 1123b formed in the arm 1123c of the diaphragm 1123. FIG. 43 is aplan view of the sensor die 1001, which is observed in the perpendicular direction to the diaphragm 1123 without illustrating the plate 1162 and the cover 1161. The diaphragm holes 1123b are entirely aligned in the flexible portion of the arm 1123c of the diaphragm 1123. Substantially the same distance is set between the centers of the diaphragm holes 1123b adjoining together.

Next, the operation of the condenser microphone using the sensor die 1001 will be described with reference to FIGS. 24A and 24B.

FIG. 24B shows an equivalent circuit which is configured by connecting the sensor die 1001 to the circuit die. A charge pump CP installed in the circuit die applies a stable bias voltage to the diaphragm 1123. As the bias voltage becomes higher, the sensitivity of the condenser microphone becomes higher, which in turn easily causes a stiction for fixing the diaphragm 1123 to the plate 1162; hence, the rigidity of the plate 1162 is an important factor in designing the sensor die 1001.

Sound waves entering into the through-hole of the package (not shown) are propagated toward the diaphragm 1123 via the plate holes 1162c, the slit S, and the cover holes 1161c. Since sound waves of the same phase are propagated on both sides of the plate 1162, the plate 1162 do not substantially vibrate. Sound waves reaching the diaphragm 1123 vibrates the diaphragm 1123 relative to the plate 1162 and the substrate 1100. When the diaphragm 1123 vibrates, electrostatic capacitance of a parallel-plate condenser (whose opposite electrodes correspond to the plate 1162 and the diaphragm 1123) is varied, wherein variations of electrostatic capacitance are converted into electric signals, which are then amplified by an amplifier A of the circuit die.

Since the cover 1161 is electrically separated from the plate 1162 via the slit S and is thus placed in an electrically floating state, no parasitic capacitance is formed between the cover 1161 and the arms 1123c of the diaphragm 1123.

Since the substrate 1100 is short-circuited with the diaphragm 1123, parasitic capacitance occurs between the plate 1162 (which does not substantially vibrate) and the substrate 1100 without the intervention of the guard electrode 1125a as shown in FIG. 24A. By forming a voltage-follower circuit using the amplifier A whose output terminal is connected to the guard electrode 1125a as shown in FIG. 24B, it is possible to prevent parasitic capacitance from being formed between the plate 1162 and the substrate 1100. That is, the guard electrodes 1125a which are insulated from the diaphragm 1123 are arranged between the plate supports 1131 (composed of the upper insulating film 1130) and the lower insulating film 1110 in the region in which the plate 1162 overlaps with the substrate 1100 in the perpendicular direction to the surface of the substrate 1100 as shown in FIG. 22A, wherein the guard electrodes 1125a are each connected to the output terminal of the amplifier A via guard connectors 1125b as well as the guard ring 1125c, and the guard lead 1125d, thus reducing parasitic capacitance in the region between the plate 1162 and the substrate 1100. When the guard lead 1125d is wired in the region opposite to the plate lead 1162d extended from the joint 1162a of the plate 1162 as shown in FIGS. 21 and 23, it is possible to prevent parasitic capacitance from occurring between the plate lead 1162d and the substrate 1100.

The condenser microphone of the second embodiment can be installed in various electronic devices such as video cameras and personal computers, wherein the housing of each electronic device should have a through-hole for propagating sound waves toward the condenser microphone. This causes a possibility in that dust may enter into the package of the condenser microphone via the through-hole of the housing of an electronic device and the through-hole of the package. In the second embodiment, it is necessary for dust to be transmitted through at least any one of the slit S, the plate holes 1162c, and the cover holes 1161c before entering into the gap layer C3 between the diaphragm 1123 and the plate 1162. It is possible to reduce the width of the slit S, the diameter of the plate hole 1162c, and the diameter of the cover hole 1161c as small as possible within the size for transmitting the etchant therethrough. The sensor die 1001 of the second embodiment is capable of reliably preventing foreign matter from entering into the gap layer C3 between the diaphragm 1123 and the plate 1162 and the gap layer C2 between the diaphragm 1123 and the substrate 1100. The projections 1161a of the cover 1161, which project toward the center portion 1162b of the plate 1162 so as to cover the arms 1123c of the diaphragm 1123, are supported by the projections 1132b of the cover support 1132 in the prescribed region close to the center portion 1162b of the plate 1162, whereby they are difficult to be deformed. This prevents the projections 1161a of the cover 1161 from being brought into contact with the arms 1123c of the diaphragm 1123.

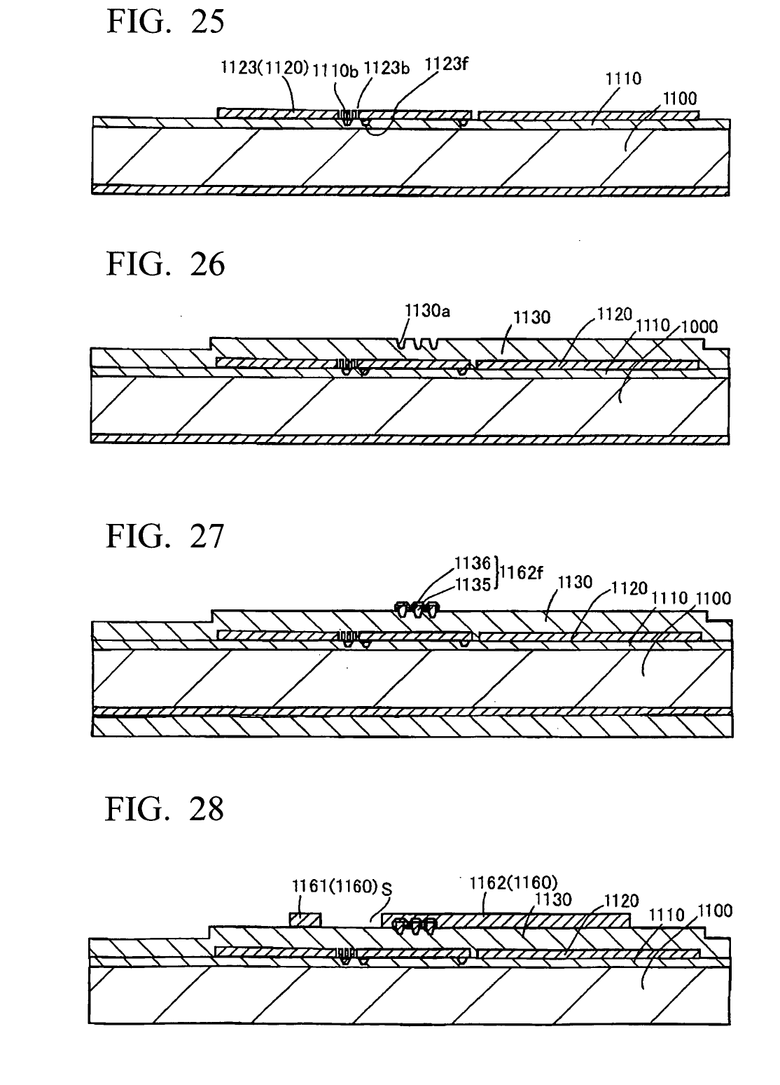

Next, a manufacturing method of the condenser microphone using the sensor die 1001 of the second embodiment will be described with reference to FIGS. 25 to 41, each of which is a sectional view taken along line E-E in FIG. 21.

In a first step of the manufacturing method shown in FIG. 25, the lower insulating film 1110, which is composed of silicon oxide, is formed entirely on the surface of the substrate 1100. A mold 1110b (used for the formation of the diaphragm bumps 1123f) is formed in the lower insulating film 1110 by way of etching using a photoresist mask. Then, the lower conductive film 1120, which is a deposited film composed of polycrystal silicon, is formed on the surface of the lower insulating film by way of CVD, whereby the diaphragm bumps 1123f are formed at the positions defined by the mold 1110b. In addition, the lower conductive film 1120 is etched using a photoresist mask to have a prescribed shape, thus forming the diaphragm 1123 (composed of the lower conductive film 1120).

In a second step of the manufacturing method shown in FIG. 26, the upper insulating film 1130 composed of silicon oxide is formed on the surfaces of the lower insulating film 1110 and the lower conductive film 1120. A mold 1130A (used for the formation of the plate bumps 1162f) is formed in the upper insulating film 1130 by etching using a photoresist mask.

In a third step of the manufacturing method shown in FIG. 27, the plate bumps 1162f are formed using a polycrystal silicon film 1135 and the silicon nitride film 1136 on the upper insulating film 1130.

In a fourth step of the manufacturing method shown in FIG. 28, the upper conductive film 160 composed of polycrystal silicon; is formed on the surfaces of the upper insulating film 1130 and the surface of the silicon nitride film 1136 by way of CVD. Then, the upper conductive film 1160 is etched using a photoresist mask so as to form the plate 1162, and the cover 1161, which are physically separated from each other via the slit S. In this step, the plate holes 1162c are not formed in the plate 1162.

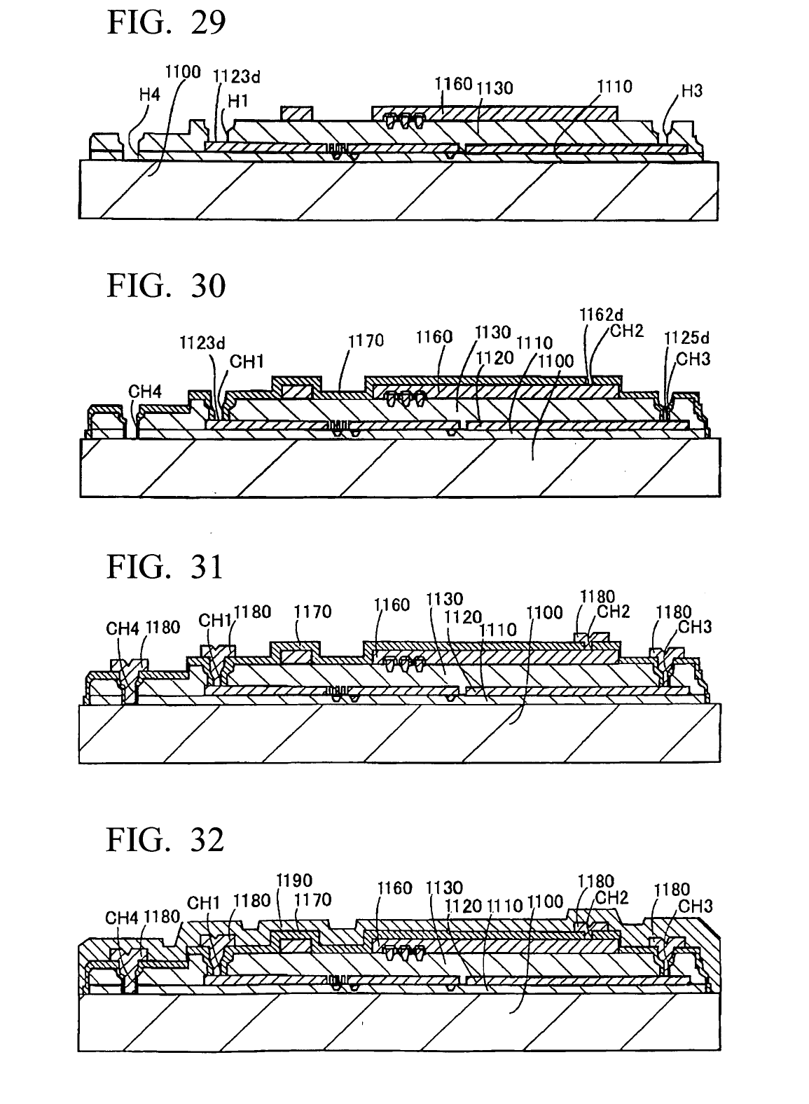

In a fourth step of the manufacturing method shown in FIG. 29, through-holes H1, H3, an H4 for exposing the diaphragm lead 1123d, the guard lead 1125d, and the substrate 1100 are formed in the lower insulating film 1110 and the upper insulating film 1130 by way of anisotropic etching using a photoresist mask

In a fifth step of the manufacturing method shown in FIG. 30, the surface insulating film 1170 composed of silicon oxide is entirely formed on the surface of the upper insulating film 1130 and the surface of the upper conductive film 1160 as well as the insides of the through-holes H1, H3, and H4 by way of plasma CVD. In addition, the remaining portions of the surface insulating film 1170 remaining in the bottoms of the through-holes H1, H3, and H4 are removed by way of etching using a photoresist mask, thus forming contact holes CH1, CH2, CH3, and CH4 in the surface insulating film 1170. This makes it possible to expose the diaphragm lead 1123d, the plate lead 1162d, the guard lead 1125d, and the substrate 1100.

In a sixth step of the manufacturing method shown in FIG. 31, a conductive film composed of AlSi is formed on the entire surface of the surface insulating film 1170 so as to cover the contact holes CH1, CH2, CH3, and CH4 and to join the diaphragm lead 1123d, the plate lead 1162d, the guard lead 1125d, and the substrate 1100 by way of sputtering. In addition, etching is performed using a photoresist mask so as to partially remove the conductive film of AlSi while leaving prescribed parts covering the contact holes CH1, CH2, CH3, and CH4, thus forming pads 1180 (composed of the deposited film of AlSi).

In a seventh step of the manufacturing method shown in FIG. 32, a pad protection film 1190 composed of silicon nitride is formed on the surface of the surface insulating film 1170 and the surfaces of the pads 1180 by way of low-stress plasma CVD, thus protecting the side surfaces of the pads 1180.

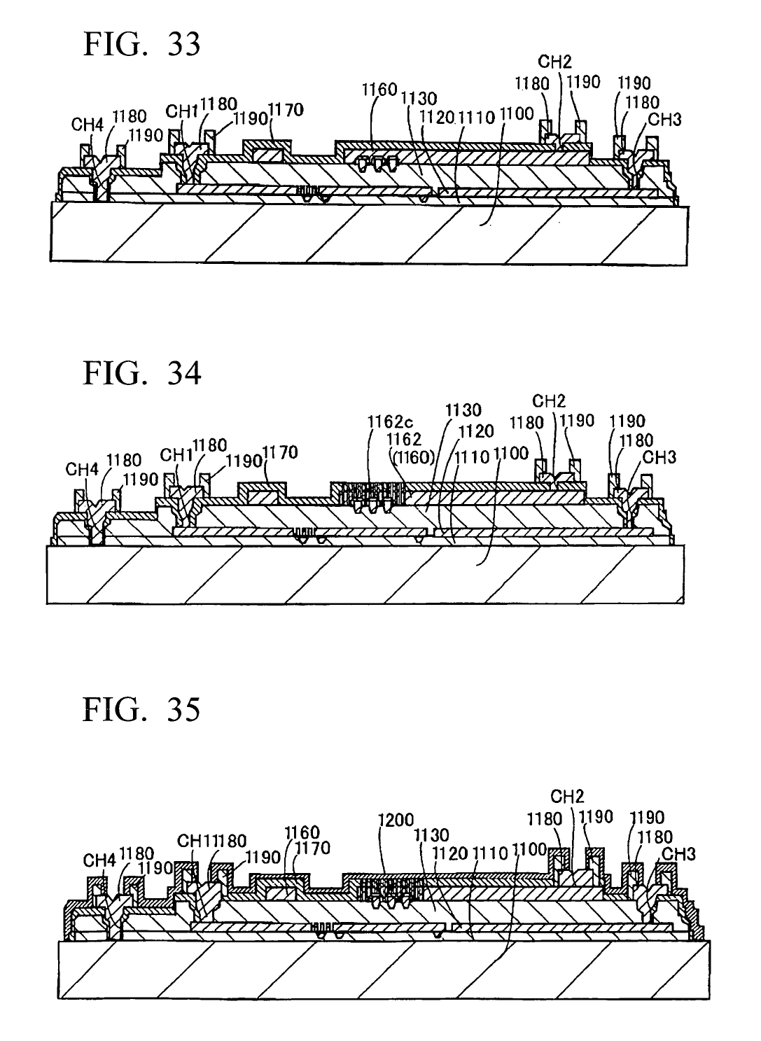

In a ninth step of the manufacturing method shown in FIG. 33, the pad protection film 1190 is subjected to dry etching using a photoresist mask so as to partially remove the pad protection film 1190 while leaving prescribed parts remaining in proximate areas and surrounding areas of the pads 1180.

In a tenth step of the manufacturing method shown in FIG. 34, through-holes are formed in the surface insulating film 1170 by way of anisotropic etching using a photoresist mask in conformity with the plate holes 1162c and the cover holes 1161c. By using the surface insulating film 1170 as an etching mask, the plate holes 1162c and the cover holes 1161c are formed in the upper conductive film 1160.

In an eleventh step of the manufacturing method shown in FIG. 35, a plating protection film 1200 composed of silicon oxide is entirely formed on the surface of the surface insulating film 1170, the surfaces of the pads 1180, and the surface of the pad protection film 1190. Next, the plating protection film 1200 is subjected to patterning while leaving the prescribed portions of the plating protection film 1200 covering the surface insulating film 1170 and the pad protection film 1190 by way of etching using a photoresist mask, thus exposing the center portions of the surfaces of the pads 1180 embedded in the contact holes CH1, CH2, CH3, and CH4.

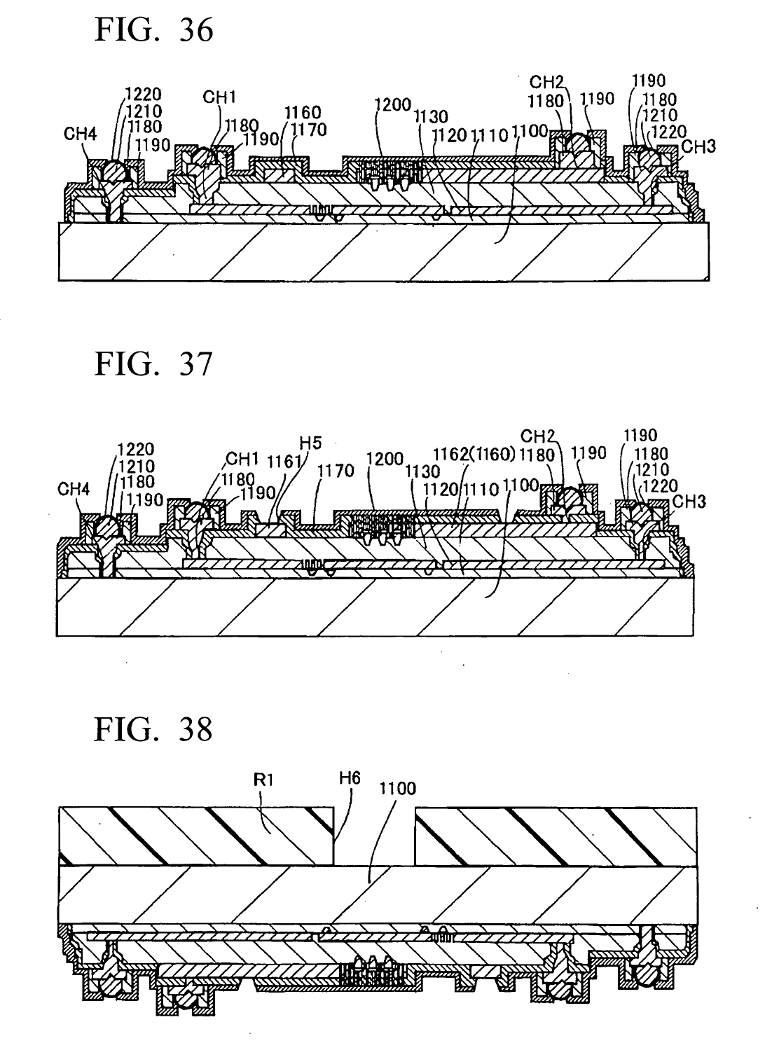

In a twelfth step of the manufacturing method shown in FIG. 36, bump films 1210 composed of nickel (Ni) are formed on the exposed surfaces of the pads 1180 in the through-holes of the plating protection film 1200 by way of electroless plating. In addition, bump protection films 1220 composed of gold (Au) are formed on the bump films 1210. Furthermore, the backside of the substrate 1100 is polished so as to achieve a desired thickness used in a product.

In a thirteenth step of the manufacturing method shown in FIG. 37, a ring-shaped hole H5 for exposing the cover 1161 is formed on the plating protection film 1200 and the surface insulating film 1170 by way of etching using a photoresist mask.

In a fourteenth step of the manufacturing method shown in FIG. 38, a photoresist mask R1 having a through-hole H6 is formed on the backside of the substrate 1100 in order to form a through-hole corresponding to the back cavity C1.

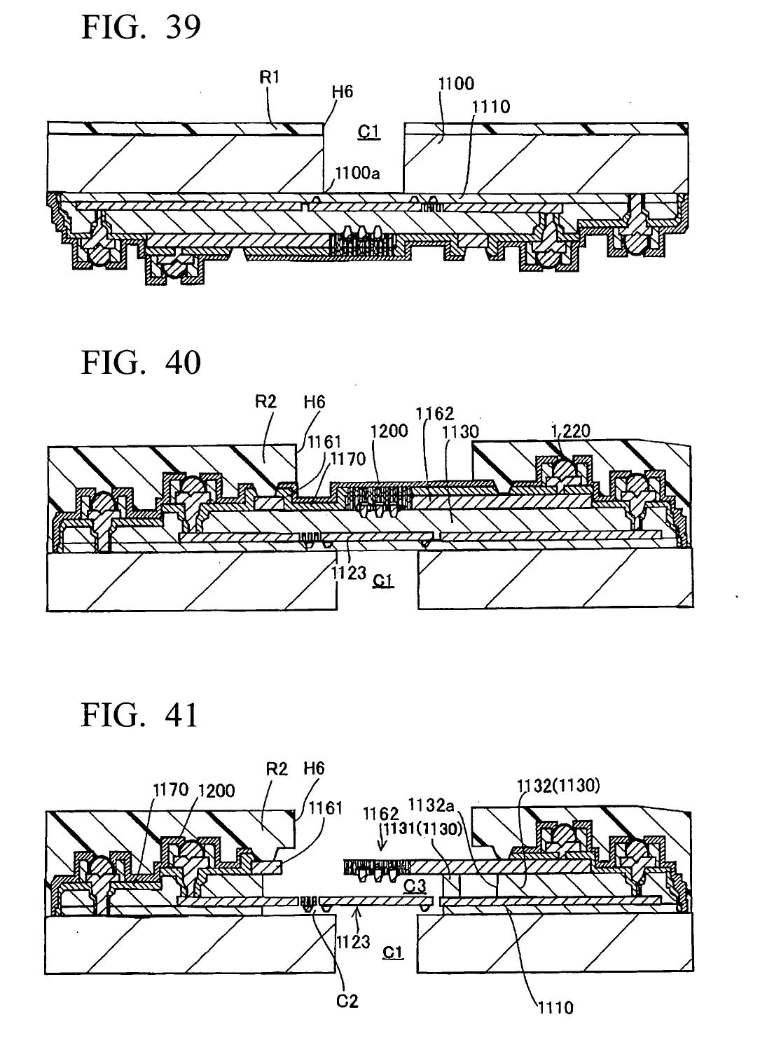

In a fifteenth step of the manufacturing method shown in FIG. 39, Deep-RIE (Deep Reactive Ion Etching, i.e. Bosch process) is performed so as to form a through-hole corresponding to the back cavity C1 in the substrate 1100. In this step, the lower insulating film 1110 serves as an etching stopper.

In sixteenth and seventeenth steps of the manufacturing method shown in FIGS. 40 and 41, isotropic etching is performed using a photoresist mask R2 and buffered hydrofluoric acid (BHF) so as to remove the plating protection film 1200 and the surface insulating film 1170 exposed in the through-hole H6 of the photoresist mask R2 and to further remove a part of the upper insulating film 1130, thus forming the cover support 1132, the plate support 1131, and the gap layer C3. At the same time, a part of the lower insulating film 1110 is removed from the back cavity C1 so as to form the gap layer C2 between the diaphragm 1123 and the substrate 1100. Thus, the outline of the upper insulating film 1130 is defined in a self-alignment manner by the plate 1162 and the cover 1161, while the outline of the lower insulating film 1110 is defined in a self-alignment manner by the opening 1100a of the substrate 1100, the diaphragm 1123, the guard electrodes 1125a, the guard connectors 1125b, and the guard ring 1125c. Remaining portions of the upper insulating film 1130 after etching are used to form the plate supports 1131 and the cover support 1132. That is, the slit S (which is formed in the fourth step shown in FIG. 28), and the plate holes 1162c and the cover holes 1161c (which are formed in the tenth step shown in FIG. 34) function as through-holes for transmitting the etchant to the upper insulating film 1130 so as to simultaneously form the gap layer C3 and the plate supports 1131. For this reason, the plate holes 1162c are aligned in consideration of the shape of the plate supports 1131 and the etching speed. That is, the plate holes 1162c are formed with equal spacing therebetween on the center portion 1162b and the joints 1162a of the plate 1162 except for the joint areas joined with the plate supports 1131 and the surrounding areas. The cover holes 1161c are aligned with equal spacing therebetween in the center areas of the projections 1161a, which project toward the center portion 1162b of the plate 1162.

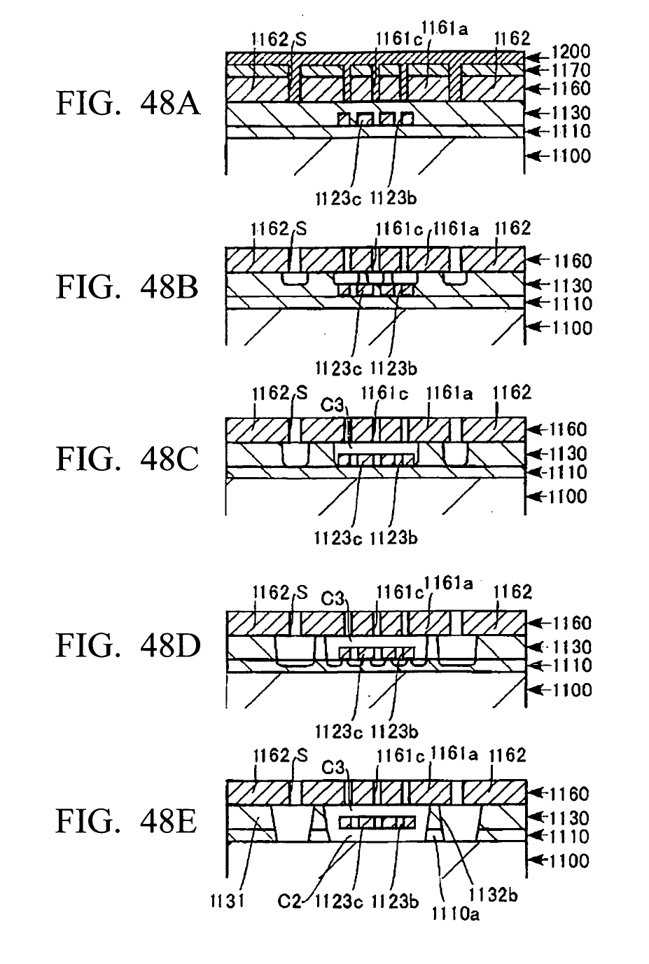

Next, an etching process for etching the upper insulating film 1130 and the lower insulating film 1110 in proximity to the arms 1123c of the diaphragm 1123 with reference to FIGS. 48A to 48E. As shown in FIG. 48A, an etchant (e.g. BHF) reaches the upper insulating film 1130 by etching the plating protection film 1200 embedded in the cover holes 1161c and the slit S. At this time, the surface insulating film 1170 which is composed of silicon oxide in a similar manner to the plating protection film 1200 is removed as well. Subsequently, the etchant reaching the surface of the upper insulating film 1130 is used to etch the upper insulating film 1130 from the edges of the cover holes 1161c and the edges of the slit S in an isotropic manner as shown in FIG. 48B. Since etching of the upper insulating film 1130 progresses in a direction parallel to the interface between the upper conductive film 1160 and the upper insulating film 1130, the upper insulating film 1130 is removed from the prescribed regions between the projections 1161a of the cover 1161 and the flexible portions of the arms 1123c of the diaphragm 1123 as shown in FIG. 48C. This in turn release the supports adapted to the projections 1161c of the cover 1161 except for both sides thereof. Subsequently, the etchant reaching the interface between the upper insulating film 1130 and the lower insulating film 1110 is used to continue etching on the upper insulating film 1130 and the lower insulating film 1110 in an isotropic manner as shown in FIG. 48D. At this time, the etching progresses on the edges of the diaphragm holes 1123b and both sides of the arms 1123c in a direction parallel to the interface between the upper insulating film 1130 and the lower insulating film 1110. As a result, the lower insulating film 1110 is removed from the prescribed regions between the substrate 1100 and the flexible portions of the arms 1123c of the diaphragm 1123 as shown in FIG. 48E. In this case, the positions and dimensions of the slit S and the cover holes 1161c are determined such that the upper insulating film 1130 and the lower insulating film 1110 still remain as the cover support 1132 just below both sides of the projections 1161c of the cover 1161 while the lower insulating film 1110 still remains as the diaphragm support just below the distal ends of the arms 1123c even when the upper insulating film 1130 and the lower insulating film 1110 are completely removed from the upper and lower parts of the flexible portions of the arms 1123c. Due to the isotropic etching on the upper insulating film 1130 and the lower insulating film 1110, the hammerhead-shaped distal ends of the arms 1123c of the diaphragm 1123 are held between the upper insulating film 1130 and the lower insulating film 1110 and are thus supported.

Lastly, the photoresist mask R2 is removed from the semiconductor structure of FIG. 41, which is then subjected to dicing, thus completing the production of the sensor die 1001 for use in the condenser microphone. The sensor die 1001 and the circuit die are bonded onto a package substrate (not shown); then, terminals of the sensor die 1001, terminals of the circuit die, and the package substrate are electrically connected together; thereafter, a package cover (not shown) is attached to the package substrate, thus completing the production of the condenser microphone. Since the sensor die 1001 is bonded onto the package substrate, the cavity C1 is closed in the backside of the substrate 1100.

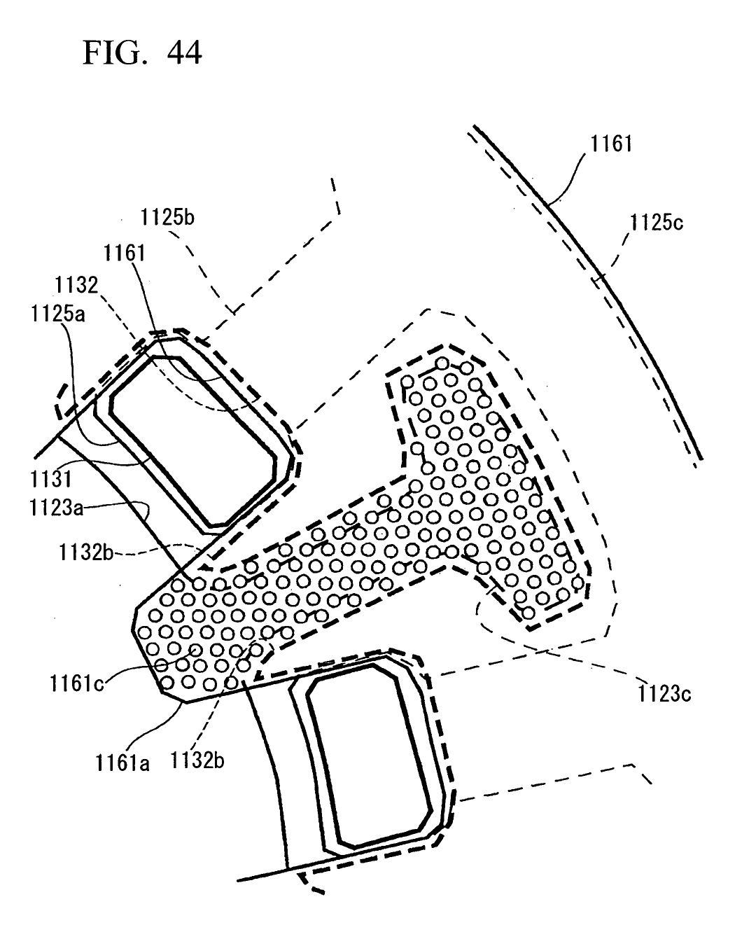

The sensor die 1001 of the second embodiment can be further modified in a variety of ways; hence, variations will be described with reference to FIGS. 44 to 47.

### (1) First Variation

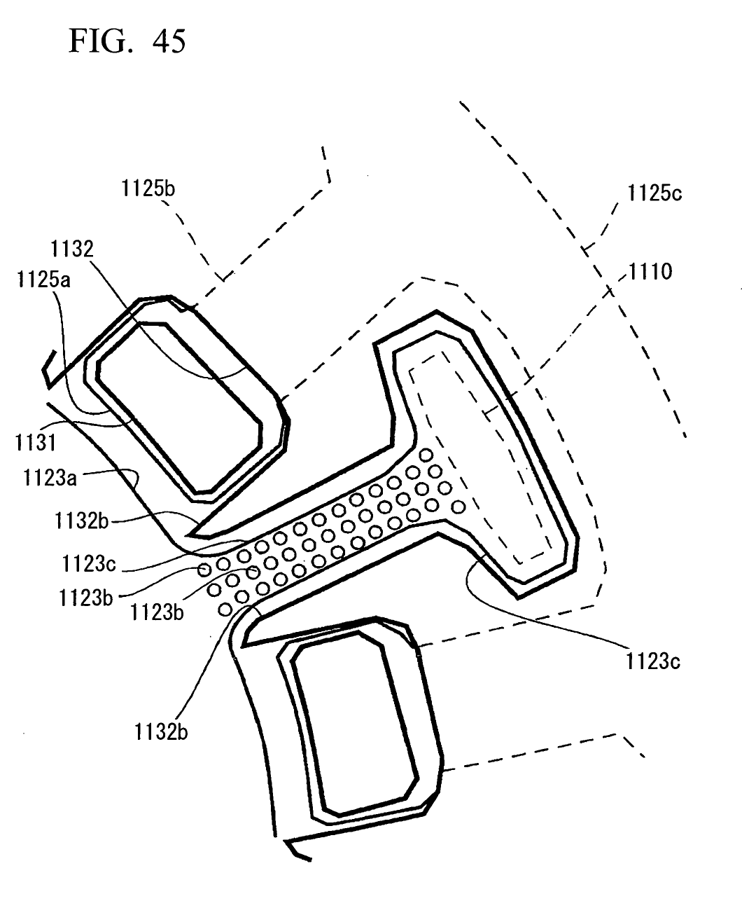

FIG. 44 shows the shape and alignment of the cover holes 1161c in accordance with a first variation of the second embodiment, wherein FIG. 44 is a plan view of the sensor die 1001 in the perpendicular direction to the diaphragm 1123 without illustrating the plate 1162. The cover holes 1161c can be aligned in the prescribed region of the cover 1161 which is positioned opposite to the arms 1123c (including the hammerhead-shaped distal ends thereof) and the center portion 1123a of the diaphragm 1123. No diaphragm hole 1123b is formed in the hammerhead-shaped distal ends of the arms 1123c, which are only connected to the lower insulating film 1110 (for supporting the diaphragm 1123), thus forming a gap between the distal ends of the arms 1123c and the cover 1161. As shown in FIG. 45, the internal outline of the cover support 1132 is shaped to surround the arms 1123c. FIG. 45 is a plan view of the sensor die 1001 in the perpendicular direction to the diaphragm 1123 without illustrating the plate 1162 and the cover 1161.

### (2) Second Variation

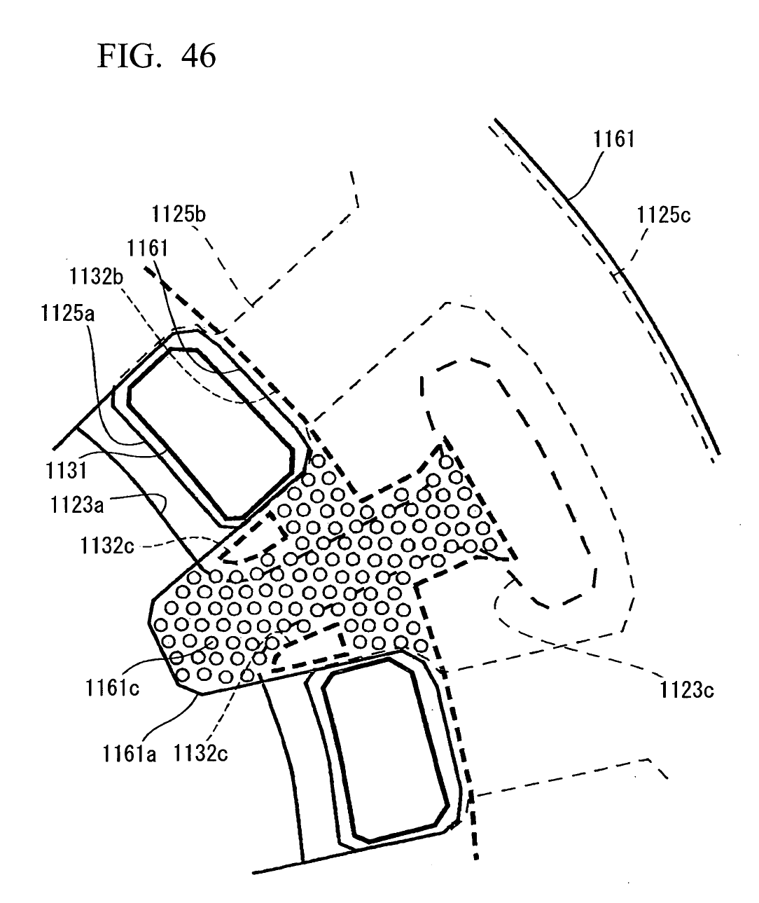

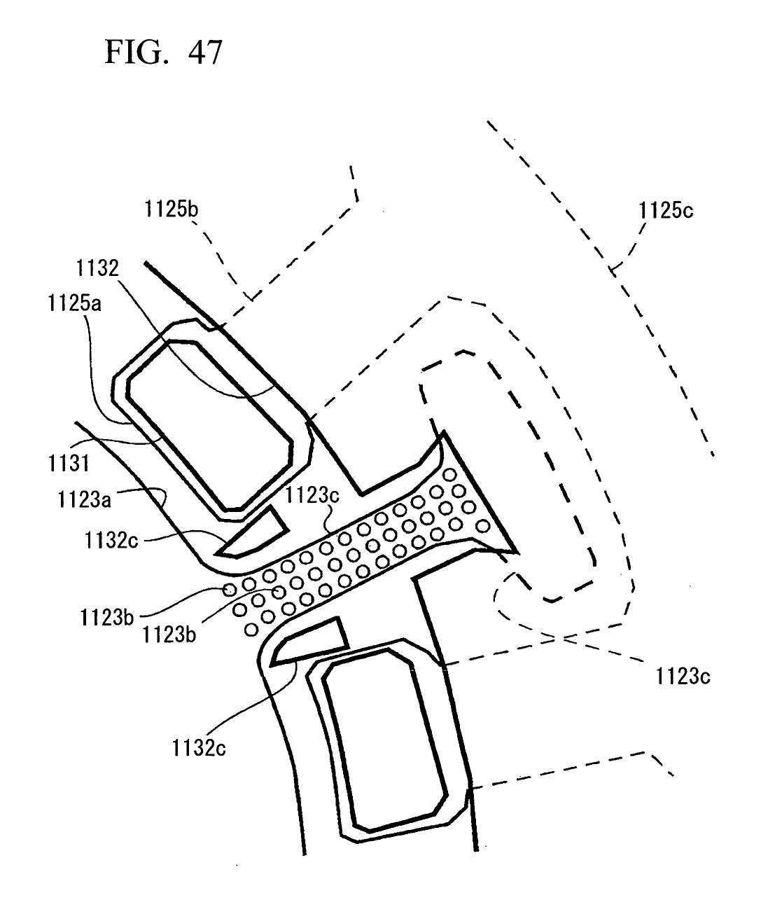

FIG. 46 is a plan view of the sensor die 1001 in the perpendicular direction to the diaphragm 1123 without illustrating the plate 1162. FIG. 47 is a plan view of the sensor die 1101 in the perpendicular direction of the diaphragm 1123 without illustrating the plate 1162 and the cover 1161.

As shown in FIGS. 46 and 47, it is possible to additionally form a plurality of pillar-shaped portions 1132c which are physically separated from a peripheral portion 1132d of the cover support 1132. That is, the cover support 1132 is constituted of the peripheral portion 1132d and the pillar-shaped portions 1132c, which are physically separated from each other, wherein the projections 1161a of the cover 1161 are supported by the pillar-shaped portions 1132c. As shown in FIG. 46, the cover holes 1161c are additionally formed in the prescribed region of the cover 1161 which is positioned opposite to the separated region by which the peripheral portion 1132d of the cover support 1132 is separated from the pillar-shaped portions 1132c.

The second embodiment and variations are illustrative and not restrictive; hence, they can be further modified in a variety of ways. For example, the width of the slit S formed between the plate 1162 and the cover 1161 is not necessarily limited to a fixed value; hence, the slit S can be partially broadened in width. In addition, it is possible to incorporate the above elements such as the charge pump P and the amplifier A installed in the circuit die into the sensor die 1001, thus forming a one-chip structure of the condenser microphone.

Moreover, the materials and dimensions defined in the first and second embodiments are illustrative and not restrictive, wherein the first and second embodiments are described without the explanation regarding the addition and deletion of steps and the change of the order of steps which may be obvious to those skilled in the art. In the manufacturing method, the film compositions, film formation methods, methods for forming outlines of films, and order of steps can be appropriately determined in response to combinations of film materials (whose properties match requirements of condenser microphones), film thicknesses, and required precisions of forming outlines of parts and components; hence, they are not restricted by the above description of the first embodiment.

Lastly, the present invention is not necessarily limited to the above embodiments and variations, which can be further modified in a variety of ways within the scope of the invention defined by the appended claims.

1. A vibration transducer comprising:
a substrate having a back cavity having an opening;
a diaphragm having a conductive property, which is formed above the substrate so as to cover the opening of the back cavity in plan view;
a plate having a conductive property, which is formed above the diaphragm and which is constituted of a center portion, which is positioned opposite to the diaphragm, and a plurality of joints which are extended from the center portion in a radial manner;
an insulating support layer, which joins the joints of the plate so as to support the plate above the diaphragm with a gap layer therebetween while insulating the plate from the diaphragm, wherein the insulating support layer has a ring-shaped interior surface for surrounding the air layer therein; and
a cover, which is formed using at least a part of a film material used for forming the plate, which joins the insulating support layer while projecting inwardly from the ring-shaped interior surface so as to surround the plate therein, and which is positioned opposite to the diaphragm with the gap layer therebetween,
wherein the cover is electrically separated from the plate via a slit, and
wherein the diaphragm vibrates relative to the plate so as to vary electrostatic capacitance formed between the diaphragm and the plate.

2. A vibration transducer according to claim 1, wherein a plurality of holes is formed in the plate and the cover so as to transmit an etchant therethrough, thus simultaneously forming the gap layer and the insulating support layer by way of isotropic etching.

3. A vibration transducer according to claim 1, wherein the diaphragm is constituted of a center portion, which is positioned opposite to the center portion of the plate, and a plurality of arms which are extended from the center portion in a radial manner, and wherein the plurality of joints of the plate is positioned between the plurality of arms of the diaphragm in plan view and is supported by the insulating support layer.

4. A vibration transducer according to claim 1, wherein the insulating support layer is formed by a plurality of pillar structures.

5. A manufacturing method for manufacturing a vibration transducer including a substrate having a back cavity having an opening; a diaphragm formed above the substrate so as to cover the opening of the back cavity in plan view; a plate which is formed above the diaphragm and is constituted of a center portion positioned opposite to the diaphragm and a plurality of joints extended from the center portion in a radial manner; an insulating support layer which joins the joints of the plate so as to support the plate above the diaphragm with a gap layer therebetween while insulating the plate from the diaphragm, wherein the insulating support layer has a ring-shaped interior surface for surrounding the air layer therein; and a cover, which is formed using at least a part of a film material used for forming the plate, which joins the insulating support layer while projecting inwardly from the ring-shaped interior surface so as to surround the plate therein, and which is positioned opposite to the diaphragm with the gap layer therebetween, wherein the cover is electrically separated from the plate via a slit,
said manufacturing method comprising the steps of:
forming a plurality of plate holes in the plate;
forming a plurality of cover holes in the cover;
performing isotropic etching using a mask corresponding to the plate and the cover so as to remove a part of the insulating support layer, thus forming the air layer between the plate and the diaphragm,
wherein the plurality of plate holes and the plurality of cover holes transmit an etchant to the insulating support layer.

6. A pressure transducer comprising:
a substrate having an opening on a surface thereof;
a plate formed above the substrate, wherein the plate is constituted of a center portion, which overlaps with the opening of the substrate in plan view, and a plurality of joints which are extended in a radial direction from the center portion and which are fixed to the surface of the substrate;
a diaphragm formed between the substrate and the plate, wherein the diaphragm is constituted of a center portion, which is positioned opposite to the center portion of the plate, and a plurality of arms which are extended in a radial direction from the center portion so as not to overlap with the joints of the plate in plan view and whose distal ends having flexibility are fixed to the surface of the substrate, whereby the diaphragm is deformed due to pressure applied to the center portion in a range between the substrate and the plate;
a cover having a plurality of projections which project inwardly in a circumferential direction, wherein the cover is shaped to engage with but is physically separated from the plate with a slit therebetween in such a way that the projections thereof are positioned in cutouts formed between the joints of the plate adjoining together; and
a cover support which is inserted between the cover and the diaphragm so as to support the cover in parallel with the surface of the substrate in a prescribed region close to the center portion rather than the distal ends of the arms of the diaphragm, thus physically separating the cover from the diaphragm.

7. A pressure transducer according to claim 6, wherein the diaphragm is composed of a lower conductive film, while both the cover and the plate are composed of an upper conductive film.

8. A pressure transducer according to claim 6, wherein a plurality of holes is formed in both of the plate and the cover so as to transmit an etchant, which is used in etching for forming a gap between the plate and the diaphragm, a gap between the cover and the diaphragm, and the cover support in a self-alignment manner, therethrough.

9. A manufacturing method of a pressure transducer including a substrate having an opening, a plate constituted of a center portion and a plurality of joints and having a plurality of plate holes, a diaphragm constituted of a center portion and a plurality of arms, a cover having a plurality of projections and a plurality of cover holes, and a cover support inserted between the cover and the diaphragm so as to support the cover in parallel with the surface of the substrate,
said manufacturing method comprising;
forming a lower insulating film on the substrate;
forming a lower conductive film used for forming the diaphragm on the lower insulating film;
forming an upper insulating film on the lower conductive film;
forming an upper conductive film used for forming the plate and the cover on the upper insulating film; and
performing isotropic etching using a mask corresponding to the substrate, the plate, and the cover so as to partially remove the lower insulating film and the upper insulating film, thus forming a gap between the substrate and the diaphragm and a gap between the diaphragm and the plate while forming the cover support by use of remaining portions of the lower insulating film and the upper insulating film.

10. The manufacturing method of a pressure transducer according to claim 9, wherein the plate is positioned inside the cover with a slit therebetween in such a way that the joints of the plate alternately engage with the projections of the cover.

11. The manufacturing method of a pressure sensor according to claim 9, wherein the plurality of plate holes and the plurality of cover holes transmit an etchant for use in the isotropic etching so as to form the cover support using the lower insulating film and the upper insulating film in a self-alignment manner.
